(19) United States
(12) Patent Application Publication
(10) Pub. No.: US 2017/0143585 A1
(43) Pub. Date: May 25, 2017

(54) BEAUTY TREATMENT DEVICE AND BEAUTY TREATMENT METHOD

(71) Applicant: PANASONIC INTELLECTUAL PROPERTY MANAGEMENT CO., LTD., Osaka (JP)

(72) Inventors: Kaori SUZUKI, Osaka (JP); Wataru SANEMATSU, Kyoto (JP); Shigeru TATSUTA, Osaka (JP)

(21) Appl. No.: 15/342,892

(22) Filed: Nov. 3, 2016

(30) Foreign Application Priority Data
Nov. 20, 2015 (JP) 2015-227479

(51) Int. Cl. A61H 35/00; A46B 13/00; B08B 3/10; B08B 5/04; B08B 3/02; B08B 3/08

(52) U.S. Cl. CPC A61H 35/00; B08B 3/02; B08B 3/08; B08B 3/10; B08B 5/04; A46B 13/008

(57) ABSTRACT

A beauty treatment device includes an alkaline water storage that stores alkaline water to be supplied to a skin of a user, and an alkaline water passage having an alkaline water outlet, from which the alkaline water stored in the alkaline water storage is discharged. The beauty treatment device includes an alkaline water supplying mechanism that supplies the alkaline water to the skin of the user, and a heating unit that heats the alkaline water. The beauty treatment device further includes a dirt removing mechanism that removes dirt attached to the skin of the user. Accordingly, there are provided a beauty treatment device and a beauty treatment method which are capable of easily removing sebum, dirt, keratotic plugs, and the like in pores.

### BACKGROUND

1. Field of the Invention

The present disclosure relates to a beauty treatment device and a beauty treatment method.

2. Description of the Related Art

A conventional beauty treatment device is disclosed, for example, in Unexamined Japanese Patent Publication No. H10-263044 (hereinafter referred to as “PTL 1”). The beauty treatment device includes a tank that stores a liquid, a spout that gushes out the liquid in the tank to outside, and a piston pump provided on the way of passage from the tank to the spout.

In the beauty treatment device of PTL 1, the piston pump is activated to discharge the liquid in the tank as a pulsating jet stream from the spout. The pulsating jet stream discharged from the spout is applied to a scalp or the like. This removes sebum, dirt, keratotic plugs, and the like adhered to pores of the scalp and the like.

However, the sebum, dirt, keratotic plugs, and the like are normally adhered to the pores in an intricately mixed state. It is thus difficult to facilitate removal of the sebum, the dirt, the keratotic plugs, and the like adhered to the pores in the intricately mixed state by mere application of the pulsating jet stream to the scalp and the like as in the above conventional technique.

### SUMMARY OF THE INVENTION

The present disclosure provides a beauty treatment device and a beauty treatment method which are capable of more easily removing sebum, dirt, keratotic plugs, and the like in pores.

The beauty treatment device of the present disclosure includes an alkaline water storage that stores alkaline water to be supplied to a skin of a user, and an alkaline water passage having an alkaline water outlet, from which the alkaline water stored in the alkaline water storage is discharged. The beauty treatment device further includes an alkaline water supplying mechanism that supplies the alkaline water to the skin of the user, a heating unit that heats the alkaline water, and a dirt removing mechanism that removes dirt attached to the skin of the user.

With this configuration, hydrolysis of proteins of the keratotic plugs and the like adhered to the pores and the like is promoted by the heated alkaline water to soften the adhered dirt. It is thereby possible to obtain the beauty treatment device capable of more easily removing the dirt adhered to the pores and the like.

The beauty treatment method of the present disclosure includes, by use of the above beauty treatment device, removing the dirt attached to the skin of the user by the dirt removing mechanism while the heated alkaline water is supplied to the skin of the user by the alkaline water supplying mechanism.

It is thereby possible to remove the dirt adhered to the pores and the like while softening the dirt. Accordingly, the dirt adhered to the pores and the like can be removed more easily.

### BRIEF DESCRIPTION OF THE DRAWINGS

FIG. 1 is a perspective view showing a beauty treatment device according to a first exemplary embodiment of the present disclosure;

FIG. 2 is a sectional view showing the beauty treatment device according to the first exemplary embodiment;

FIG. 3 is a sectional view showing a beauty treatment device according to a second exemplary embodiment of the present disclosure;

FIG. 4 is a sectional view showing a beauty treatment device according to a third exemplary embodiment of the present disclosure;

FIG. 5 is a sectional view showing a beauty treatment device according to a fourth exemplary embodiment of the present disclosure;

FIG. 6 is a front view showing a beauty treatment device according to a fifth exemplary embodiment of the present disclosure;

FIG. 7 is a sectional view showing the beauty treatment device according to the fifth exemplary embodiment;

FIG. 8 is a perspective view showing a beauty treatment device according to a sixth exemplary embodiment of the present disclosure; and

FIG. 9 is a sectional view showing the beauty treatment device according to the sixth exemplary embodiment.

### DETAILED DESCRIPTION

Hereinafter, exemplary embodiments of the present disclosure will be described with reference to the drawings. Note that the present disclosure is not limited to these exemplary embodiments.

In the following, descriptions are given defining the side on which an alkaline water outlet is located during normal use of a beauty treatment device as an upper side of the beauty treatment device.

A plurality of exemplary embodiments described below include similar components. Hence, the similar components are provided with a common reference numeral, and a description thereof may not be repeated.

### First Exemplary Embodiment

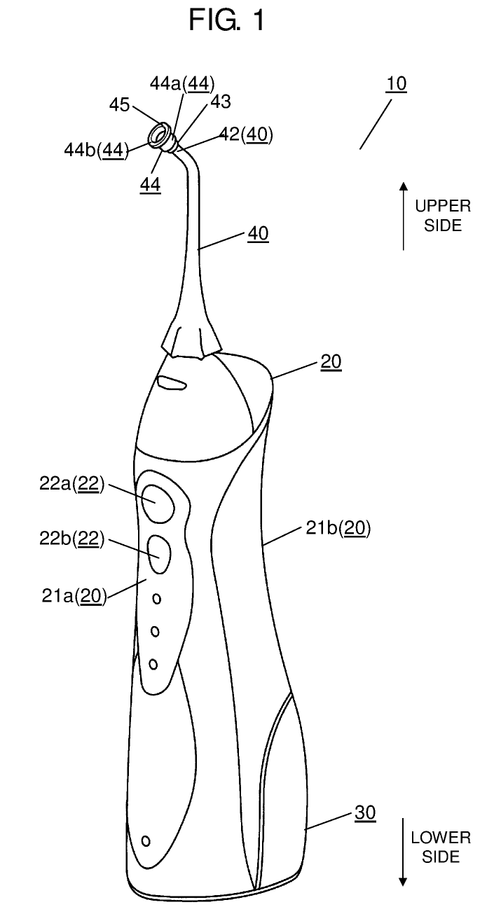

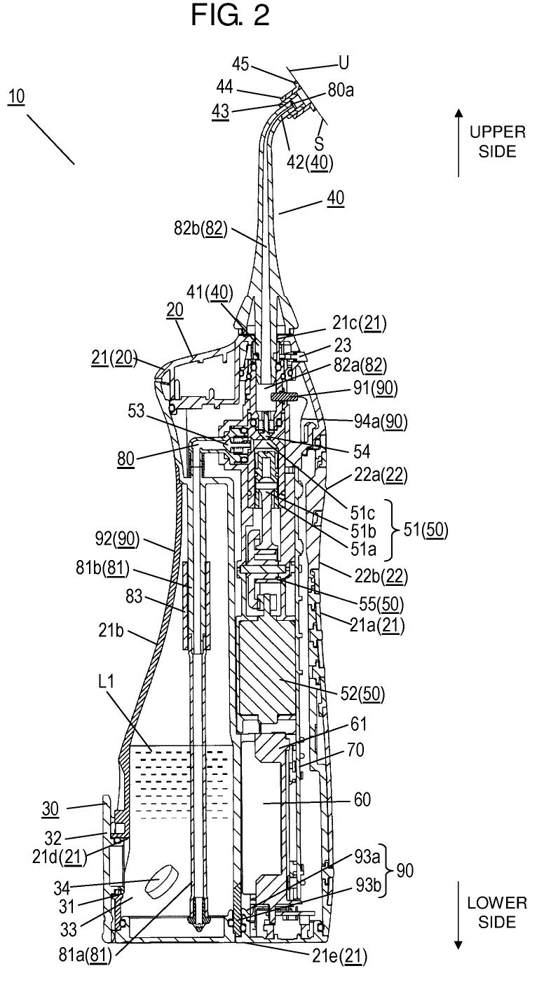

Hereinafter, a beauty treatment device according to the first exemplary embodiment will be described with reference to FIGS. 1 and 2.

FIG. 1 is a perspective view showing the beauty treatment device according to the first exemplary embodiment of the present disclosure. FIG. 2 is a sectional view showing the beauty treatment device according to the first exemplary embodiment.

As shown in FIGS. 1 and 2, beauty treatment device 10 of the present exemplary embodiment includes body 20 provided with gripper 21a, tank case 30, nozzle part 40, and the like. Tank case 30 is detachably mounted to a lower part of body 20. Nozzle part 40 is detachably mounted to an upper part of body 20.

Note that beauty treatment device 10 of the present exemplary embodiment is exemplified by a device or the like in which alkaline water L1 stored inside is discharged from alkaline water outlet 80a formed at tip 42 of nozzle part 40 to skin S of user U to remove dirt attached to skin S.

Hereinafter, a specific description is given of a configuration of beauty treatment device 10 of the present exemplary embodiment.

Body 20 includes elongated, substantially tubular (including tubular) casing 21 formed of an insulating synthetic resin, such as an ABS resin. Casing 21 accommodates main components, described below, in the tube.

Casing 21 includes gripper 21a at a substantially central part (including a central part) in a longitudinal direction. Gripper 21a has recess 21b curved so as to project inward. In recess 21b, a region to be gripper 21a of casing 21 is made thin. This makes the shape of gripper 21a easier to be gripped by a hand of the user.

Bottom 21e of casing 21 is formed by a flat surface. Accordingly, beauty treatment device 10 can stably stand with nozzle part 40 upward when beauty treatment device 10 is not used.

Further, gripper 21a is provided such that finger-side electrode 92, switch 22, and the like are exposed on the surface of gripper 21a. Finger-side electrode 92 is formed, for example, in a slit elongated shape along the longitudinal direction of gripper 21a (body 20). Thus, when user U grasps gripper 21a, beauty treatment device 10 is easily brought into close contact with the hand, and is more easily brought into an electrically conducted state, for example.

Switch 22 includes power supply switch 22a, mode switch 22b, and the like, and is provided in a position opposite to finger-side electrode 92 (in front of beauty treatment device 10). Power supply switch 22a switches ON/OFF the power supply of beauty treatment device 10. Mode switch 22b selectively switches to a predetermined operation mode.

Upper opening 21c is formed at the upper end of casing 21. Projection 41 of nozzle part 40 described above is inserted into upper opening 21c. Nozzle part 40 is thereby detachably mounted to the upper part of body 20. Note that push button 23 that can be pushed up and down is mounted to the upper end of casing 21. It is configured such that, for example by user U performing pushing operation on push button 23, nozzle part 40 is disconnected from body 20 (casing 21) and becomes detachable.

Lower opening 21d is formed at the lower end of casing 21. Tank case 30 is inserted into lower opening 21d. Tank case 30 is thereby detachably mounted to the lower part of body 20. It is configured such that upon mounting of tank case 30 to the lower part of body 20, alkaline water storage 33 for storing alkaline water L1 is formed inside tank case 30.

With the configuration of detachable tank case 30, user U can remove tank case 30 from body 20 for easy cleaning.

Opening 31 to be closed by lid 32 is formed on a side wall of tank case 30. By removal of lid 32, water can be supplied from opening 31 into alkaline water storage 33.

In beauty treatment device 10 of the present exemplary embodiment, lid 32 is removed, tablet 34 for pH adjustment, for example, is put into alkaline water storage 33, and water such as tap water is supplied. This generates alkaline water L1. Note that a method for storing alkaline water L1 in alkaline water storage 33 is not limited to the above method. For example, previously prepared alkaline water L1 may be directly supplied and stored into alkaline water storage 33.

Alkaline water L1 stored in alkaline water storage 33 is preferably adjusted to have pH in the range from 9 to 12. Adjusting pH of alkaline water L1 within the above range enables suppression of irritation to eyes and skin S of user U being supplied with alkaline water L1. It is thereby possible to obtain a high beauty effect while ensuring safety.

Further, beauty treatment device 10 of the present exemplary embodiment includes alkaline water passage 80 for allowing passage of alkaline water L1 stored in alkaline water storage 33. Alkaline water passage 80 has, at a downstream end, alkaline water outlet 80a for discharging alkaline water L1 out of beauty treatment device 10. Alkaline water L1 in alkaline water storage 33 thereby passes through alkaline water passage 80, to be discharged from alkaline water outlet 80a to skin S and the like of the user.

Beauty treatment device 10 of the present exemplary embodiment further includes an alkaline water supplying mechanism configured by pump unit 50 and the like. In the alkaline water supplying mechanism, alkaline water L1 stored in alkaline water storage 33 is discharged from alkaline water outlet 80a via alkaline water passage 80. Then, discharged alkaline water L1 is supplied to skin S of user U.

Specifically, pump unit 50 that functions as the alkaline water supplying mechanism is provided on the way of alkaline water passage 80. It is configured such that by activation of pump unit 50, alkaline water L1 stored in alkaline water storage 33 is sprayed from alkaline water outlet 80a via alkaline water passage 80.

Alkaline water passage 80 thus has suction-side passage 81 for supplying pump unit 50 with alkaline water L1 stored in alkaline water storage 33. Further, alkaline water passage 80 has alkaline water outlet 80a, and has discharge-side passage 82 through which alkaline water L1 in pump unit 50 is introduced.

Suction-side passage 81 is disposed in body 20, and is configured by tube 81a and pipe 81b. During normal use of beauty treatment device 10, the tip of tube 81a is disposed in the state of being soaked in alkaline water L1 in alkaline water storage 33. Pipe 81b is continuously provided downstream of tube 81a and upstream of pump unit 50.

Meanwhile, discharge-side passage 82 is formed in nozzle part 40, and is configured by casing inner passage 82a and nozzle inner passage 82b. Casing inner passage 82a is continuously provided downstream of pump unit 50. Upon mounting of nozzle part 40 to the upper part of body 20, nozzle inner passage 82b is continuously provided upstream of casing inner passage 82a.

Alkaline water outlet 80a described above is formed at tip 42 of nozzle part 40.

Pump unit 50 is built-in in body 20, and is configured by piston pump 51 having a single tube, for example, electric motor 52 for driving piston pump 51, and motion changing mechanism part 55 including a gear, a link, and the like, for example.

Electric motor 52 is electrically connected to storage battery 60 constituting a power supply, and is driven by electric power of storage battery 60.

Piston pump 51 is configured by tubular cylinder 51a, piston 51b retractably inserted into the tube of cylinder 51a, volume chamber 51c, and the like. Piston pump 51 expands and contracts volume chamber 51c in accordance with reciprocating motion of piston 51b. Alkaline water L1 is thereby sucked from alkaline water storage 33 and discharged from alkaline water outlet 80a via volume chamber 51c that expands and contracts.

Motion changing mechanism part 55 changes the rotation of electric motor 52 to the reciprocating motion of piston 51b.

Volume chamber 51c communicates with suction-side passage 81 (pipe 81b) via check valve 53 on the suction side. Further, volume chamber 51c communicates with discharge-side passage 82 (casing inner passage 82a) via check valve 54 on the discharge side. For this reason, when piston 51b is lowered (moves to the lower side of FIG. 2) and volume chamber 51c becomes larger (expands), check valve 53 on the suction side opens. Alkaline water L1 thus flows from suction-side passage 81 into volume chamber 51c. On the other hand, when piston 51b is raised (moves to the upper side of FIG. 2) and volume chamber 51c becomes smaller (contracts), check valve 54 on the discharge side opens. Alkaline water L1 is thus discharged from volume chamber 51c to discharge-side passage 82, and discharged from alkaline water outlet 80a to skin S of the user. At this time, check valve 54 on the discharge side is closed in the suction stroke of piston 51b, and check valve 53 on the suction side is opened in the discharge stroke of piston 51b. That is, by driving of piston pump 51, the flow of alkaline water L1 is constantly blocked at the upstream or downstream of check valve 53 and check valve 54.

Other than piston pump 51 and electric motor 52 which constitute pump unit 50 described above, storage battery 60 as a power supply, circuit board 70, and the like are built-in in the hollow (in the tube) of casing 21. Circuit board 70 controls electric power that is supplied to electric motor 52 and the like. Storage battery 60 is supported by battery holder 61 fixed onto circuit board 70. Circuit board 70 is provided with a conductive passage for electrically connecting storage battery 60 and finger-side electrode 92, and a conductive passage for electrically connecting storage battery 60 with skin-side electrode 91.

That is, during use of beauty treatment device 10, finger-side electrode 92 in contact with the fingers of user U is connected to one pole of storage battery 60 via the conductive passage. Meanwhile, skin-side electrode 91 in contact with skin S of nostrils or the like of user U is connected to the other pole of storage battery 60 via the conductive passage.

Note that skin-side electrode 91 of beauty treatment device 10 of the present exemplary embodiment is brought into contact with the other pole of storage battery 60 via lead wire 94a constituting a part of the conductive passage. Skin-side electrode 91 is electrically connected to skin S of user U at least via alkaline water L1 flowing in alkaline water passage 80.

That is, skin-side electrode 91 is provided so as to be exposed in discharge-side passage 82 (casing inner passage 82a) of alkaline water passage 80 and to face discharge-side passage 82 located downstream of check valves 53, 54. Alkaline water L1 in discharge-side passage 82 is thereby used as the conductive passage between skin-side electrode 91 and skin S of user U.

Further, in the present exemplary embodiment, alkaline water L1 upstream of check valves 53, 54 is used as a part of the conductive passage for electrically connecting storage battery 60 and finger-side electrode 92. Specifically, finger-side electrode 92 is disposed so as to face an inner surface of alkaline water storage 33 in a conductible state. Further, counter electrode 93b is exposed and disposed in a portion facing finger-side electrode 92 of body 20, to electrically connect counter electrode 93b and storage battery 60 via lead wire 93a. Hence, alkaline water L1 is used as a part of the conductive passage for electrically connecting storage battery 60 and finger-side electrode 92. This can shorten and simplify wiring made up of a long lead wire required for wiring between storage battery 60 and finger-side electrode 92. Consequently, the labor and time in manufacturing related to, for example, wiring and the like can be reduced, to improve workability.

In this case, the conductive passage for electrically connecting storage battery 60 and finger-side electrode 92 is preferably formed near a bottom (a lower part) of alkaline water storage 33. This enables alkaline water L1 in alkaline water storage 33 to effectively function as the conductive passage even with a small amount of stored alkaline water L1. In the present exemplary embodiment, as shown in FIG. 2, the inner surface of finger-side electrode 92 is disposed so as to face the bottom of alkaline water storage 33, and counter electrode 93b is disposed adjacent to the bottom of alkaline water storage 33.

Further, as described above, alkaline water L1 in upstream alkaline water passage 80 (suction-side passage 81) is also used as the conductive passage between storage battery 60 and finger-side electrode 92. In this case, alkaline water L1 in alkaline water passage 80 may cause occurrence of a short circuit between the poles of storage battery 60.

Hence, in beauty treatment device 10 of the present exemplary embodiment, check valves 53, 54 normally block the conductive passage formed of alkaline water L1 between suction-side passage 81 and discharge-side passage 82. That is, check valves 53, 54 block the electric connection between alkaline water L1 in suction-side passage 81 and alkaline water L1 in discharge-side passage 82. This prevents occurrence of a short circuit between the poles of storage battery 60 caused by alkaline water L1 in alkaline water passage 80.

As described above, beauty treatment device 10 of the present exemplary embodiment is configured such that, during use of beauty treatment device 10, alkaline water L1 supplied by operation of pump unit 50 forms energization mechanism 90 for energizing skin S.

That is, beauty treatment device 10 is configured so as to form a circuit from one pole of storage battery 60 to the other pole of storage battery 60 through circuit board 70, lead wire 94a, skin-side electrode 91, alkaline water L1 (from the inside of discharge-side passage 82 to skin 5), skin S of user U (the skin of face, arm, etc.), finger-side electrode 92, alkaline water L1 in suction-side passage 81, counter electrode 93b, lead wire 93a, and circuit board 70. In this manner, a massaging effect on skin S by energization is realized.

At this time, a current caused to flow in the circuit including skin S may be either a direct current or an alternate current, and may further be a fixed-value current or a pulsed current. Further, the energization may be performed by using circuit board 70 and periodically switching the positive and negative of the current, for example as in a low-frequency therapeutic device. In this manner, the massaging effect on skin S is further enhanced.

In the present exemplary embodiment, the description has been given by taking, as an example, beauty treatment device 10 provided with energization mechanism 90 for energizing skin S. However, the present disclosure is not limited thereto. For example, the beauty treatment device may be configured to include no energization mechanism 90. In this manner, an inexpensive product dedicated to removal of keratotic plugs and the like can be provided.

Further, beauty treatment device 10 of the present exemplary embodiment may have the following configuration so as to more easily remove sebum, dirt, keratotic plugs, and the like which attach to the pores of skin S of user U.

Specifically, for example, heating unit 83 for heating alkaline water L1 may be provided on a periphery of suction-side passage 81 (pipe 81b). Then, alkaline water L1 heated in heating unit 83 is discharged to skin S of user U. Note that a heater or the like is usable as heating unit 83.

At this time, heating unit 83 preferably heats alkaline water L1 to be discharged from alkaline water outlet 80a such that a temperature of alkaline water L1 becomes 37° C. to 50° C. The above temperature range is preferred because, when the temperature of alkaline water L1 to be discharged to skin S is set equal to or higher than 37° C., the temperature of alkaline water L1 becomes equal to or higher than a temperature of the skin. This enables the dirt, such as the keratotic plugs, attached to skin S to be softened through hydrolysis or the like. As a result, the dirt can be more easily removed. Meanwhile, when the temperature of alkaline water L1 to be discharged to skin S is set equal to or lower than 50° C., a thermal effect exerted by the temperature of alkaline water L1 on skin S can be suppressed. This enables suppression of thermal damage on skin S during removal of the dirt. As a result, beauty treatment device 10 which is safe and excellent in reliability can be obtained.

In beauty treatment device 10 of the present exemplary embodiment, cylindrical splash preventer 43 formed of, for example, an ABS resin or the like may be provided on a periphery of alkaline water outlet 80a (near alkaline water outlet 80a). During use of beauty treatment device 10, splash preventer 43 can prevent splashing of alkaline water L1 discharged to skin S, and scattering of alkaline water L1 to the periphery of beauty treatment device 10.

Further, in beauty treatment device 10 of the present exemplary embodiment, guide part 44 may be provided on a periphery of splash preventer 43 (on the periphery of alkaline water outlet 80a). Guide part 44 is formed of, for example, an ABS resin or the like, and provided with a cylindrical tube part 44a, and a flange part 44b extending from the tip of tube part 44a to the outer peripheral side. Hence, a distance and an angle between alkaline water outlet 80a and skin S can be kept in the optimum state. Guide part 44 guides alkaline water L1 so as to be discharged in one direction (a substantially vertical direction (including a vertical direction) to skin 5). This can maximize the effect of removal of the keratotic plugs and the like.

When splash preventer 43 is not provided, guide part 44 may be provided on the periphery of alkaline water outlet 80a at tip 42 of nozzle part 40.

In the above, the description has been given of the example in which splash preventer 43 and guide part 44 are formed of different members. However, splash preventer 43 and guide part 44 may be formed of one member. This leads to improvement in design.

Further, in beauty treatment device 10 of the present exemplary embodiment, detector 45 may be provided at flange part 44b (on the periphery of alkaline water outlet 80a) being the tip of guide part 44. Detector 45 detects a state of contact between guide part 44 and skin S. A known sensor can be used as detector 45. Examples of the sensor include a sensor for detecting the contact state based on energization or non-energization, and a sensor for detecting the contact state based on whether or not predetermined spring pressure has been added. Note that detector 45 is connected with circuit board 70 via lead wires disposed inside nozzle part 40 excluding nozzle inner passage 82b, and disposed inside body 20.

When detector 45 does not detect the contact between flange part 44b of guide part 44 (on the periphery of alkaline water outlet 80a) and skin S, a controller (not shown) mounted on circuit board 70, for example, performs control such that alkaline water L1 is not discharged. This can prevent scattering and the like of alkaline water L1 due to operation of switch 22 by the user when flange part 44b is not in contact with skin S.

When guide part 44 is not provided, detector 45 may be provided at the tip of splash preventer 43. When splash preventer 43 is not provided, either, detector 45 may be provided at tip 42 of nozzle part 40.

Beauty treatment device 10 of the present exemplary embodiment is configured as above.

Hereinafter, a description is given of a beauty treatment method using beauty treatment device 10 having the above configuration, based on an example of operation and effect of beauty treatment device 10.

First, user U removes lid 32 of tank case 30, puts tablet 34 for pH adjustment into alkaline water storage 33, and supplies water such as tap water. This generates alkaline water L1. In the present exemplary embodiment, alkaline water L1 with pH in the preferable range from 9 to 12, for example about pH 11.5, is generated and stored in alkaline water storage 33.

At this time, alkaline water L1 may be directly supplied into tank case 30 which has been removed from casing 21, and may be stored in alkaline water storage 33.

Subsequently, tank case 30 is inserted into lower opening 21d of casing 21.

Next, detector 45, provided at tip 42 of nozzle part 40 (flange part 44b), is brought into contact with the surface of skin S of the nostrils, for example. In this contact state, user U operates switch 22.

Pump unit 50 is driven when switch 22 is operated with beauty treatment device 10 (flange part 44b) in contact with skin S of user U. On the other hand, as described above, when beauty treatment device 10 is not in contact with skin S, detector 45 does not detect the contact between guide part 44 and skin S. Hence in that state, even if user U operates switch 22, pump unit 50 does not move.

That is, pump unit 50 is driven when switch 22 is turned on with detector 45 having detected the contact with skin S. When piston 51b of piston pump 51 in pump unit 50 is lowered by drive, volume chamber 51c expands. This leads to opening of check valve 53 on the suction side. As a result, alkaline water L1 in alkaline water storage 33 passes through suction-side passage 81 of alkaline water passage 80 to flow into volume chamber 51c of piston pump 51.

At this time, heating unit 83 provided on the periphery of suction-side passage 81 (pipe 81b) heats passing alkaline water L1 to, for example, about 40° C. (in the range from 37° C. to 50° C.). Heated alkaline water L1 thereby flows into volume chamber 51c.

Next, when piston 51b of piston pump 51 is raised, volume chamber 51c contracts. This leads to closing of check valve 53 on the suction side, and opening of check valve 54 on the discharge side. As a result, alkaline water L1 in volume chamber 51c is discharged from volume chamber 51c to discharge-side passage 82.

By the reciprocating operation of piston 51b of piston pump 51, volume chamber 51c repeatedly expands and contracts (this corresponds to the alkaline water supplying mechanism).

Sucked alkaline water L1 thereby passes through discharge-side passage 82, to be sprayed from alkaline water outlet 80a toward skin S, at the surface of the nostrils, and the like, of user U.

That is, heated alkaline water L1 is sprayed from alkaline water outlet 80a, to be supplied to the surface of skin S of user U. At this time, supplied alkaline water L1 softens the dirt adhered to the pores and the like of user U through hydrolysis or the like. At the same time, the dirt adhered to the pores and the like is blown off and removed by spraying force of alkaline water L1 sprayed onto skin S (this corresponds to the dirt removing mechanism). This enables skin S to be kept in a dirt-free state.

As described above, a beauty treatment method is performed by using beauty treatment device 10 of the present exemplary embodiment.

The beauty treatment method using beauty treatment device 10 of the present exemplary embodiment is as follows. First, heated alkaline water L1 is supplied to skin S of user U by the alkaline water supplying mechanism. While alkaline water L1 is supplied, the dirt attached to skin S of user U is removed by the dirt removing mechanism.

In beauty treatment device 10 of the present exemplary embodiment, pump unit 50 is configured to have both functions of the alkaline water supplying mechanism and the dirt removing mechanism.

As described above, beauty treatment device 10 of the present exemplary embodiment includes alkaline water storage 33 that stores alkaline water L1 to be supplied to skin S of user U, and alkaline water passage 80 having alkaline water outlet 80a, from which alkaline water L1 stored in alkaline water storage 33 is discharged. Beauty treatment device 10 further includes the alkaline water supplying mechanism that supplies alkaline water L1 to skin S of user U, heating unit 83 that heats alkaline water L1, and the dirt removing mechanism that removes the dirt attached to skin S of user U.

Accordingly, heated alkaline water L1 promotes the hydrolysis of proteins of the keratotic plugs adhered to pores and the like, to soften the adhered dirt. As a result, the dirt adhered to the pores and the like can be more easily removed.

Further, beauty treatment device 10 of the present exemplary embodiment includes, as the dirt removing mechanism, pump unit 50 capable of spraying alkaline water L1 onto skin S of user U.

That is, alkaline water L1 is sprayed onto skin S of user U to remove the dirt adhered to the pores and the like. It is thereby possible to remove the dirt by the spraying force of alkaline water L1, while softening the adhered dirt. As a result, the dirt adhered to the pores and the like can be more efficiently removed. Further, alkaline water L1 can be sprayed deep into the pores. Alkaline water L1 thus acts physically on the dirt located deep inside the pores. As a result, the dirt located deep inside the pores can be more effectively removed.

Further, in beauty treatment device 10 of the present exemplary embodiment, splash preventer 43 for preventing splashing of alkaline water L1 may be provided near alkaline water outlet 80a.

This can prevent scattering of alkaline water L1 discharged from alkaline water outlet 80a to, for example, the eyes during use of beauty treatment device 10, such as at the time of removal of the dirt on the face.

Further, in beauty treatment device 10 of the present exemplary embodiment, guide part 44 for guiding alkaline water L1 so as to be discharged in one direction (the substantially vertical direction (including a vertical direction) to skin 5) may be provided on the periphery of alkaline water outlet 80a.

It is thereby possible to discharge alkaline water L1 in the substantially vertical direction (including the vertical direction) to skin S, and supply alkaline water L1 deep into the pores. As a result, the dirt such as the keratotic plugs can be more reliably removed.

Further, in beauty treatment device 10 of the present exemplary embodiment, detector 45 for detecting a state of contact with skin S of user U may be provided on the periphery of alkaline water outlet 80a.

This can prevent alkaline water L1 from being discharged with the periphery of alkaline water outlet 80a not in contact with skin S. For example, when the periphery of alkaline water outlet 80a is not in contact with skin S, the controller performs control such that alkaline water L1 is not discharged, based on a detection result of detector 45. By this control, the discharge of alkaline water L1 is blocked when user U lifts beauty treatment device 10 from skin S during use of beauty treatment device 10. As a result, alkaline water L1 can be prevented from being erroneously sprayed onto a region other than the pores and from being scattered to the periphery.

That is, by disposing detector 45, erroneous spraying and the like of alkaline water L1 can be prevented, to improve the usability of beauty treatment device 10.

Further, beauty treatment device 10 of the present exemplary embodiment may include, as the alkaline water supplying mechanism, pump unit 50 capable of spraying alkaline water L1 onto skin S of user U.

Alkaline water L1 can be thereby sprayed onto skin S of user U, to be more efficiently supplied to skin S of user U. Further, alkaline water L1 can be supplied deep into the pores. As a result, the dirt located deep inside the pores can be more easily and effectively removed.

Moreover, in beauty treatment device 10 of the present exemplary embodiment, heating unit 83 may heat alkaline water L1 to be discharged from alkaline water outlet 80a such that the temperature of alkaline water L1 becomes 37° C. to 50° C.

The temperature of alkaline water L1 to be discharged to skin S is thus set equal to or higher than the temperature of the skin of user U. As a result, the dirt such as the keratotic plugs can be effectively softened and easily removed. Further, the temperature of alkaline water L1 to be discharged to skin S is set to a temperature (e.g., equal to or lower than 50° C.) at which a thermal effect on skin S can be suppressed. Hence, thermal damage on skin S due to high-temperature alkaline water L1 can be prevented in advance during removal of the dirt.

Further, in beauty treatment device 10 of the present exemplary embodiment, alkaline water L1 is preferably adjusted to have pH in the range from 9 to 12.

This can suppress irritation, caused by alkaline water L1, to the eyes and skin S of user U. Further, the dirt such as the keratotic plugs can be more easily removed while the irritation to skin S and the like by alkaline water L1 is suppressed.

In the beauty treatment method of the present exemplary embodiment, by using beauty treatment device 10, the dirt attached to skin S of user U is removed by the dirt removing mechanism while heated alkaline water L1 is supplied to skin S of user U by the alkaline water supplying mechanism.

Hence, the dirt attached to skin S of user U can be more easily removed. Further, the dirt attached to skin S of user U can be removed without setting the time for pre-treatment, for example, treatment of applying alkaline water or the like to the skin to soften the keratotic plugs and the like. As a result, the dirt attached to skin S of user U can be removed in a shorter time.

### Second Exemplary Embodiment

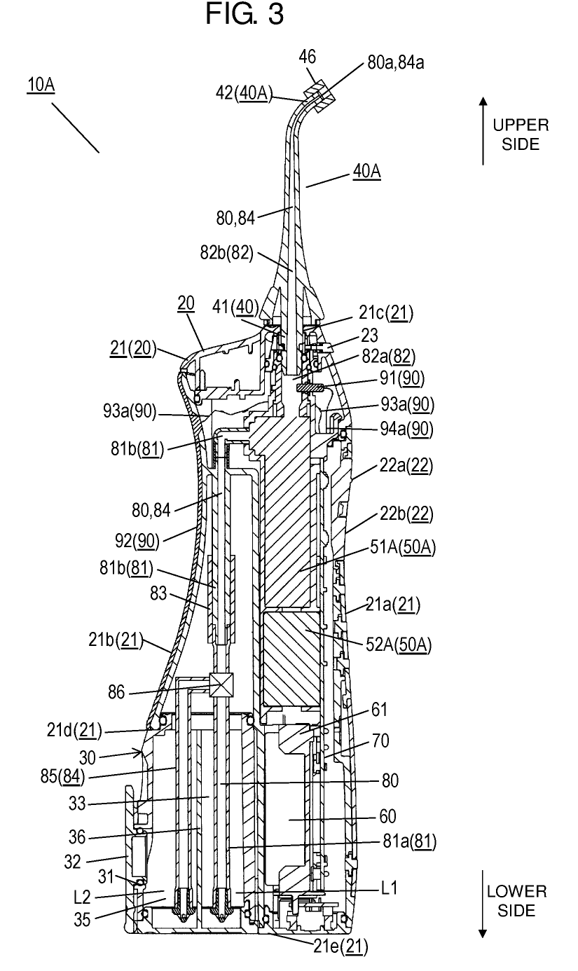

Hereinafter, a beauty treatment device according to the second exemplary embodiment will be described with reference to FIG. 3.

FIG. 3 is a sectional view showing the beauty treatment device according to the second exemplary embodiment of the present disclosure.

As shown in FIG. 3, beauty treatment device 10A of the present exemplary embodiment is different from beauty treatment device 10 of the first exemplary embodiment in that beauty treatment device 10A includes liquid storage 35, switching valve 86, alkaline water holder 46, and the like. Except for the above, beauty treatment device 10A basically has a configuration similar to the configuration of beauty treatment device 10 of the first exemplary embodiment.

That is, beauty treatment device 10A of the present exemplary embodiment includes body 20 provided with gripper 21a, tank case 30, nozzle part 40A, and the like. Tank case 30 is detachably mounted to the lower part of body 20. Nozzle part 40A is detachably mounted to the upper part of body 20.

Alkaline water holder 46 is formed of, for example, a sponge-like urethane member, and is disposed at tip 42 of nozzle part 40A (at the peripheral edge of alkaline water outlet 80a). Alkaline water holder 46 functions as the alkaline water supplying mechanism.

Alkaline water holder 46 sucks and holds alkaline water L1 discharged from alkaline water outlet 80a. At the same time, alkaline water holder 46 also has a function of supplying (applying) held alkaline water L1 to skin S of user U.

Further, similarly to beauty treatment device 10, beauty treatment device 10A of the present exemplary embodiment includes alkaline water storage 33, alkaline water passage 80, and the like. Alkaline water storage 33 stores alkaline water L1 to be supplied to skin S of user U. Alkaline water passage 80 has alkaline water outlet 80a for discharging alkaline water L1 stored in alkaline water storage 33. At this time, alkaline water L1 stored in alkaline water storage 33 is adjusted to have pH in the range from 9 to 12.

Beauty treatment device 10A of the present exemplary embodiment further includes an alkaline water supplying mechanism and a dirt removing mechanism, which are configured by pump unit 50A, heating unit 83, and the like. The alkaline water supplying mechanism is built-in in the hollow (in the tube) of casing 21, and supplies alkaline water L1 to skin S of user U. Heating unit 83 heats alkaline water L1. The dirt attached to skin S of user U is removed by the dirt removing mechanism by external force generated by spraying or suction, for example.

When pump unit 50A is activated, alkaline water L1 in alkaline water storage 33 is sucked, and passed through alkaline water passage 80, to be discharged from alkaline water outlet 80a.

At this time, alkaline water L1 is heated to, for example, about 40° C. (in the range from 37° C. to 50° C.) by heating unit 83. Heated alkaline water L1 is thus discharged from alkaline water outlet 80a to skin S.

Similarly to pump unit 50 of the first exemplary embodiment, pump unit 50A includes, for example, piston pump 51A with a single tube, and electric motor 52A for driving piston pump 51A. In FIG. 3, a specific cross-sectional configuration of piston pump 51A is omitted, and piston pump 51A is schematically shown.

Electric motor 52A is electrically connected to storage battery 60 constituting a power supply, and is driven by electric power of storage battery 60.

Also in the second exemplary embodiment, pump unit 50A is configured to have both functions of the alkaline water supplying mechanism and the dirt removing mechanism.

Further, beauty treatment device 10A of the present exemplary embodiment includes liquid storage 35 other than alkaline water storage 33 in tank case 30. The inside of tank case 30 is divided by partition 36 into liquid storage 35 and alkaline water storage 33. Liquid storage 35 stores liquid L2 different from alkaline water, for example, water L2 such as tap water. Hereinafter, a description is given taking water as an example of the liquid.

For this reason, liquid passage 84, through which water L2 stored in liquid storage 35 passes, is formed using a part of alkaline water passage 80 in beauty treatment device 10A. Liquid passage 84 includes, at a downstream end, liquid outlet 84a for discharging water L2 to the outside of beauty treatment device 10A. With the operation of pump unit 50A, water L2 stored in liquid storage 35 is discharged from liquid outlet 84a via liquid passage 84.

Note that beauty treatment device 10A of the present exemplary embodiment is configured such that alkaline water outlet 80a is also used as liquid outlet 84a.

That is, the downstream of liquid passage 84 and the downstream of alkaline water passage 80 are used as a common passage. Specifically, the downstream of a region provided with heating unit 83 in alkaline water passage 80 constitutes the common passage. Switching valve 86, which is configured by, for example, an electromagnetic valve, is provided upstream of heating unit 83 in alkaline water passage 80. Liquid passage 84 is formed by being branched from alkaline water passage 80 via branch pipe 85 that is upstream of liquid passage 84. Note that the controller (not shown) of circuit board 70 controls the switching operation of switching valve 86.

That is, the passage downstream of switching valve 86 is taken as the common passage of liquid passage 84 and alkaline water passage 80.

Water L2 stored in liquid storage 35 thereby passes through the common passage located downstream of branch pipe 85 and switching valve 86, to be discharged from liquid outlet 84a toward skin S.

At this time, a liquid supply mechanism configured by pump unit 50A supplies water L2 in liquid storage 35 to skin S of user U. That is, in the present exemplary embodiment, pump unit 50A is further provided with a function as the liquid supply mechanism in addition to the alkaline water supplying mechanism and the dirt removing mechanism.

In the present exemplary embodiment, alkaline water L1 in alkaline water storage 33 is not used as a part of wiring as in the first exemplary embodiment. Hence, finger-side electrode 92 is directly connected with circuit board 70 through lead wire 93a, to constitute energization mechanism 90.

Beauty treatment device 10A of the present exemplary embodiment is configured as above.

Hereinafter, a description is given of a beauty treatment method using beauty treatment device 10A having the above configuration, based on an example of operation and effect of beauty treatment device 10A. Note that basic operation and effect are omitted since they are similar to the basic operation and effect of the first exemplary embodiment, and different operation is mainly described.

First, user U removes lid 32 of tank case 30, puts tablet 34 for pH adjustment into alkaline water storage 33, and supplies water such as tap water. This generates alkaline water L1 adjusted to have a pH similar to that in the first exemplary embodiment. As in the first exemplary embodiment, water L2 is stored in separated liquid storage 35.

Next, alkaline water holder 46, provided at flange part (not shown) which is tip 42 of nozzle part 40, is brought into contact with the surface of skin S of the nostrils, for example. In this contact state, user U operates switch 22.

Subsequently, pump unit 50A is driven when switch 22 is turned on with a detector (not shown) having detected the contact of alkaline water holder 46 with skin S. Alkaline water L1 stored in alkaline water storage 33 is thereby sucked into alkaline water passage 80 and then flows. Flowing alkaline water L1 is heated to, for example, about 40° C. (in the range from 37° C. to 50° C.) by heating unit 83. Heated alkaline water L1 is discharged from alkaline water outlet 80a formed in nozzle part 40A. Discharged alkaline water L1 is applied to skin S by alkaline water holder 46. In beauty treatment device 10A of the present exemplary embodiment, alkaline water L1 is discharged for predetermined time, for example, about five minutes. Hence, branch pipe 85 communicating with liquid storage 35 is closed by the switching valve during discharge of alkaline water L1.

After a lapse of the predetermined time, the controller of circuit board 70 switches the passage to liquid passage 84 with switching valve 86. Water L2 in liquid storage 35 passes through liquid passage 84, to be sprayed from liquid outlet 84a toward skin S, at the surface of the nostrils, and the like, of user U.

At this time, skin S is in the state of having been applied with alkaline water L1 for the predetermined time. Hence, the dirt adhered to the pores and the like has been softened by applied alkaline water L1.

Water L2 sucked from liquid storage 35 is then sprayed toward the dirt in the softened state. Accordingly, the softened dirt is removed by the spraying force of water L2. Note that sprayed water L2 is preferably sprayed in the state of being heated to, for example, about 40° C. (in the range from 37° C. to 50° C.) by heating unit 83. However, water L2 may be sprayed while being not particularly heated.

As described above, a beauty treatment method is performed by beauty treatment device 10A of the present exemplary embodiment.

The beauty treatment method using beauty treatment device 10A of the present exemplary embodiment is as follows. First, for predetermined time, heated alkaline water L1 is applied to skin S of user U while being supplied to alkaline water holder 46 that constitutes the alkaline water supplying mechanism. Then, the dirt attached to skin S of user U is removed by the dirt removing mechanism for supplying water L2.

By this operation, operation and effect similar to those in the first exemplary embodiment are obtained.

Note that beauty treatment device 10A of the present exemplary embodiment includes, as the alkaline water supplying mechanism, alkaline water holder 46 formed at the peripheral edge of alkaline water outlet 80a. This enables supply of alkaline water L1 from alkaline water holder 46 to skin S during use of beauty treatment device 10A. As a result, the dirt and the like can be more reliably softened by increasing the time during which alkaline water L1 is in contact with the keratotic plugs and the like.

Further, beauty treatment device 10A of the present exemplary embodiment includes: liquid storage 35 that stores a liquid different from alkaline water L1, such as water L2; liquid passage 84 having liquid outlet 84a for discharging water L2; and a liquid supplying mechanism that supplies water L2 to skin S of user U. It is thereby possible to supply skin S with not only alkaline water L1, but also water L2 different from alkaline water L1. As a result, alkaline water L1 remaining on skin S can be reliably removed by water L2.

Further, beauty treatment device 10A of the present exemplary embodiment includes, as the liquid supply mechanism, pump unit 50A that sprays water L2 to skin S of user U. Water L2 can be thereby supplied deep into the pores. As a result, it is possible to reliably remove by water L2 the dirt located deep inside the pores and alkaline water L1 remaining on skin S.

In the beauty treatment method of the present exemplary embodiment, by using beauty treatment device 10A, the dirt attached to skin S of user U is removed by the dirt removing mechanism after heated alkaline water L1 is supplied to skin S of user U by the alkaline water supplying mechanism. That is, proteins of the keratotic plugs and the like are softened by alkaline water L1 through hydrolysis, and the keratotic plugs softened by the spraying of water L2 are then removed. Hence, the dirt attached to skin S of user U can be more reliably removed.

Further, alkaline water L1 supplied to skin S can be rinsed away by the spraying of water L2. Accordingly, post-treatment on skin S can be performed by water L2.

In the present exemplary embodiment, the description has been given by taking, as an example, nozzle part 40A that includes alkaline water holder 46. However, the present disclosure is not limited thereto. For example, nozzle part 40 of the first exemplary embodiment may be used. Further, nozzle part 40A of the present exemplary embodiment may be applied to the first exemplary embodiment, whereby similar operation and effect can be obtained.

### Third Exemplary Embodiment

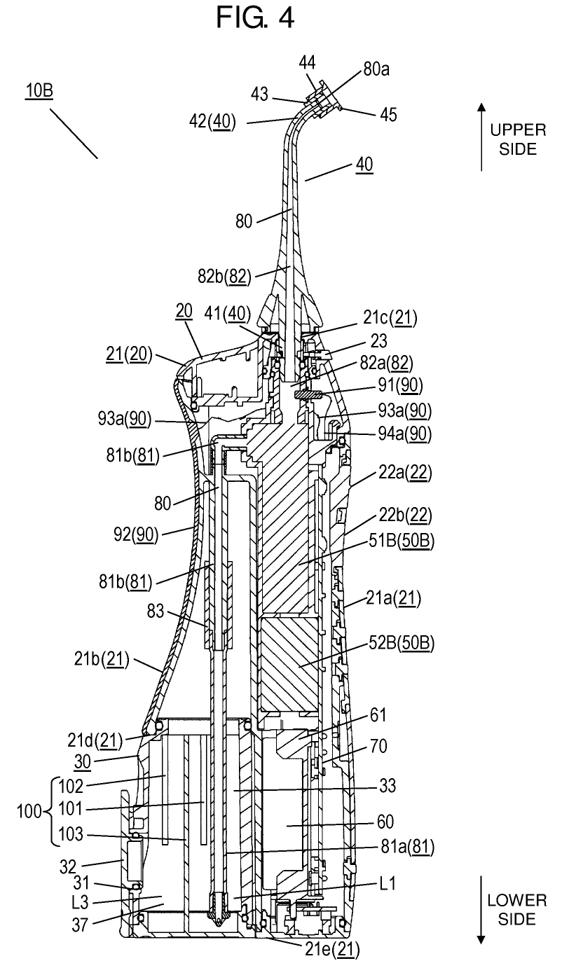

Hereinafter, a beauty treatment device according to the third exemplary embodiment will be described with reference to FIG. 4.

FIG. 4 is a sectional view showing the beauty treatment device according to the third exemplary embodiment of the present disclosure.

As shown in FIG. 4, beauty treatment device 10B of the present exemplary embodiment is different from beauty treatment device 10 of the first exemplary embodiment in that beauty treatment device 10B includes acidic water storage 37, electrolysis unit 100 that constitutes an alkaline water generator, and the like. Except for the above, beauty treatment device 10B basically has a configuration similar to the configuration of beauty treatment device 10 of the first exemplary embodiment.

That is, beauty treatment device 10B of the present exemplary embodiment includes body 20 provided with gripper 21a, tank case 30, nozzle part 40, and the like. Tank case 30 is detachably mounted to the lower part of body 20. Nozzle part 40 is detachably mounted to the upper part of body 20.

Cylindrical splash preventer 43 formed of, for example, an ABS resin or the like is provided on the periphery of alkaline water outlet 80a (near alkaline water outlet 80a).

Further, guide part 44 is provided on the periphery of splash preventer 43 (on the periphery of alkaline water outlet 80a). Guide part 44 guides alkaline water L1 so as to be discharged in one direction (the substantially vertical direction (including the vertical direction) to skin 5).

Detector 45 is provided at flange part 44b (on the periphery of alkaline water outlet 80a) being the tip of guide part 44. Detector 45 detects a state of contact between guide part 44 and skin S.

Further, similarly to beauty treatment device 10, beauty treatment device 10B of the present exemplary embodiment includes alkaline water storage 33, alkaline water passage 80, and the like. Alkaline water storage 33 stores alkaline water L1 to be supplied to skin S of user U. Alkaline water passage 80 has alkaline water outlet 80a for discharging alkaline water L1 stored in alkaline water storage 33. At this time, alkaline water L1 stored in alkaline water storage 33 is adjusted so as to have pH in the range from 9 to 12.

Beauty treatment device 10B of the present exemplary embodiment further includes an alkaline water supplying mechanism and a dirt removing mechanism which are configured by pump unit 50B, heating unit 83, and the like. The alkaline water supplying mechanism is built-in in the hollow (in the tube) of casing 21, and supplies alkaline water L1 to skin S of user U. Heating unit 83 heats alkaline water L1. The dirt attached to skin S of user U is removed by the dirt removing mechanism.

When pump unit 50B is activated, alkaline water L1 in alkaline water storage 33 is sucked, and passed through alkaline water passage 80, to be discharged from alkaline water outlet 80a.

At this time, alkaline water L1 is heated to, for example, about 40° C. (in the range from 37° C. to 50° C.) by heating unit 83. Heated alkaline water L1 is thus discharged from alkaline water outlet 80a to skin S.

Similarly to pump unit 50 of the first exemplary embodiment, pump unit 50B includes, for example, piston pump 51B with a single tube, and electric motor 52B for driving piston pump 51B. In FIG. 4, a specific cross-sectional configuration of piston pump 51B is omitted, and piston pump 51B is schematically shown.

Electric motor 52B is electrically connected to storage battery 60 constituting a power supply, and is driven by electric power of storage battery 60.

Also in the third exemplary embodiment, pump unit 50B is configured to have both functions of the alkaline water supplying mechanism and the dirt removing mechanism.

Beauty treatment device 10B of the present exemplary embodiment further includes alkaline water generator that generates alkaline water L1. The alkaline water generator is configured by electrolysis unit 100 including cathode 101, anode 102, and diaphragm 103 disposed between cathode 101 and anode 102.

The inside of tank case 30 is divided by diaphragm 103 into alkaline water storage 33 in which alkaline water L1 is stored and acidic water storage 37 in which acidic water L3 is stored.

In the present exemplary embodiment, alkaline water L1 in alkaline water storage 33 is not used as a part of wiring as in the first exemplary embodiment. Hence, finger-side electrode 92 is directly connected with circuit board 70 through lead wire 93a, to constitute energization mechanism 90.

Beauty treatment device 10B of the present exemplary embodiment is configured as above.

Hereinafter, a description is given of a beauty treatment method using beauty treatment device 10B having the above configuration based on an example of operation and effect of beauty treatment device 10B. Note that basic operation and effect are omitted since they are similar to the basic operation and effect of the first exemplary embodiment, and different operation is mainly described.

First, user U removes lid 32 of tank case 30, and supplies water such as tap water into alkaline water storage 33 and acidic water storage 37 which are divided by diaphragm 103.

Subsequently, voltage is applied to cathode 101 and anode 102 of electrolysis unit 100 which face each other via diaphragm 103, to electrolyze the water. This generates alkaline water L1 in alkaline water storage 33 where cathode 101 is disposed. At the same time, acidic water L3 is generated in acidic water storage 37 where anode 102 is disposed. At this time, alkaline water L1 stored in alkaline water storage 33 is generated by being adjusted to have pH in the range from 9 to 12, for example pH 11.5.

Next, detector 45, provided at tip 42 of nozzle part 40 (flange part 44b), is brought into contact with the surface of skin S of the nostrils, or the like, for example. In this contact state, user U operates switch 22.

At this time, pump unit 50B is driven when switch 22 is operated with beauty treatment device 10B (flange part 44b) in contact with skin S of user U.

Upon driving of pump unit 50B, alkaline water L1 stored in alkaline water storage 33 is sucked into alkaline water passage 80 and then flows. Flowing alkaline water L1 is heated to, for example, about 40° C. (in the range from 37° C. to 50° C.) by heating unit 83. Heated alkaline water L1 is sprayed from alkaline water outlet 80a, formed in nozzle part 40, toward skin S, at the surface of the nostrils, and the like, of user U.

That is, heated alkaline water L1 is sprayed from alkaline water outlet 80a, to be supplied to the surface of skin S of user U. At this time, supplied alkaline water L1 softens the dirt adhered to the pores and the like of user U through hydrolysis or the like. At the same time, the dirt adhered to the pores and the like is blown off and removed by the spraying force of alkaline water L1 sprayed onto skin S. This enables skin S to be kept in a dirt-free state.

As described above, a beauty treatment method is performed by using beauty treatment device 10B of the present exemplary embodiment.

The beauty treatment method using beauty treatment device 10B of the present exemplary embodiment is as follows. First, alkaline water L1 generated by electrolysis unit 100 is heated by heating unit 83. Then, heated alkaline water L1 is supplied to skin S of user U by the alkaline water supplying mechanism. Further, while alkaline water L1 is supplied, the dirt attached to skin S of user U is removed by the dirt removing mechanism.

Accordingly, operation and effect similar to those in the first exemplary embodiment are obtained.

As described above, beauty treatment device 10B of the present exemplary embodiment further includes an alkaline water generator that generates alkaline water L1. The alkaline water generator is configured by electrolysis unit 100 including cathode 101, anode 102, and diaphragm 103 disposed between cathode 101 and anode 102. Hence, alkaline water L1 can be easily generated through electrolysis by using tap water or the like.

In the present exemplary embodiment, the description has been given by taking, as an example, the configuration including nozzle part 40 of the first exemplary embodiment. However, the present disclosure is not limited thereto. For example, nozzle part 40A of the second exemplary embodiment may be used.

### Fourth Exemplary Embodiment

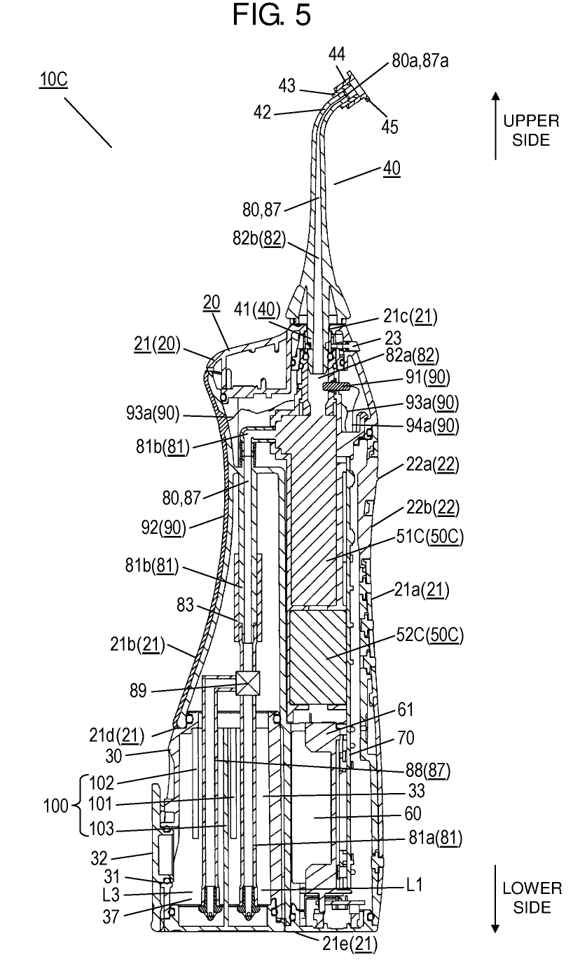

Hereinafter, a beauty treatment device according to the fourth exemplary embodiment will be described with reference to FIG. 5.

FIG. 5 is a sectional view showing the beauty treatment device according to the fourth exemplary embodiment of the present disclosure.

As shown in FIG. 5, beauty treatment device 10C of the present exemplary embodiment is different from beauty treatment device 10B of the third exemplary embodiment in that beauty treatment device 10C includes switching valve 89, branch pipe 88, and the like. Except for the above, beauty treatment device 10C basically has a configuration similar to the configuration of beauty treatment device 10B of the third exemplary embodiment.

That is, beauty treatment device 10C of the present exemplary embodiment includes body 20 provided with gripper 21a, tank case 30, nozzle part 40, and the like. Tank case 30 is detachably mounted to the lower part of body 20. Nozzle part 40 is detachably mounted to the upper part of body 20.

Cylindrical splash preventer 43 formed of, for example, an ABS resin or the like is provided on the periphery of alkaline water outlet 80a (near alkaline water outlet 80a).

Further, guide part 44 is provided to splash preventer 43 (on the periphery of alkaline water outlet 80a). Guide part 44 guides alkaline water L1 so as to be discharged in one direction (the substantially vertical direction (including the vertical direction) to skin 5).

Detector 45 is provided at flange part 44b (on the periphery of alkaline water outlet 80a) being the tip of guide part 44. Detector 45 detects a state of contact between guide part 44 and skin S.

Further, similarly to beauty treatment device 10B, beauty treatment device 10C of the present exemplary embodiment includes alkaline water storage 33, alkaline water passage 80, and the like. Alkaline water storage 33 stores alkaline water L1 to be supplied to skin S of user U. Alkaline water passage 80 has alkaline water outlet 80a for discharging alkaline water L1 stored in alkaline water storage 33. At this time, alkaline water L1 stored in alkaline water storage 33 is adjusted so as to have pH in the range from 9 to 12.

Further, beauty treatment device 10C of the present exemplary embodiment includes an alkaline water supplying mechanism and a dirt removing mechanism which are configured by pump unit 50C, heating unit 83, and the like. The alkaline water supplying mechanism is built-in in the hollow (in the tube) of casing 21, and supplies alkaline water L1 to skin S of user U. Heating unit 83 heats alkaline water L1. The dirt attached to skin S of user U is removed by the dirt removing mechanism.

When pump unit 50C is activated, alkaline water L1 in alkaline water storage 33 is sucked, and passed through alkaline water passage 80, to be discharged from alkaline water outlet 80a.

At this time, alkaline water L1 is heated to, for example, about 40° C. (in the range from 37° C. to 50° C.) by heating unit 83. Heated alkaline water L1 is discharged from alkaline water outlet 80a.

Similarly to pump unit 50B of the third exemplary embodiment, pump unit 50C includes, for example, piston pump 51C with a single tube, and electric motor 52C for driving piston pump 51C. In FIG. 5, a specific configuration of piston pump 51C is omitted, and piston pump 51C is schematically shown.

Electric motor 52C is electrically connected to storage battery 60 constituting a power supply, and is driven by electric power of storage battery 60.

Also in the fourth exemplary embodiment, pump unit 50C is configured to use both the alkaline water supplying mechanism and the dirt removing mechanism.

Further, similarly to the second exemplary embodiment, beauty treatment device 10C of the present exemplary embodiment includes alkaline water generator that generates alkaline water L1. The alkaline water generator is configured by electrolysis unit 100 including cathode 101, anode 102, and diaphragm 103 disposed between cathode 101 and anode 102.

The inside of tank case 30 is divided by diaphragm 103 into alkaline water storage 33 in which alkaline water L1 is stored and acidic water storage 37 in which acidic water L3 is stored.

For this reason, acidic water passage 87, through which acidic water L3 stored in acidic water storage 37 passes, is formed using a part of alkaline water passage 80 in beauty treatment device 10C. Acidic water passage 87 includes, at a downstream end, acidic water outlet 87a for discharging acidic water L3 to the outside of beauty treatment device 10C. With the operation of pump unit 50C, acidic water L3 stored in acidic water storage 37 is discharged from acidic water outlet 87a via acidic water passage 87.

Note that beauty treatment device 10C of the fourth exemplary embodiment is configured such that alkaline water outlet 80a is also used as acidic water outlet 87a.

That is, the downstream of acidic water passage 87 and the downstream of alkaline water passage 80 are used as a common passage. Specifically, the downstream of a region provided with heating unit 83 in alkaline water passage 80 constitutes the common passage. Switching valve 89, which is for example configured by an electromagnetic valve, is provided upstream of heating unit 83 of alkaline water passage 80. Liquid passage 84 is formed by being branched from alkaline water passage 80 via branch pipe 88 that is upstream of acidic water passage 87. Note that the controller (not shown) of circuit board 70 controls the switching operation of switching valve 89.

Further, the passage downstream of switching valve 89 is taken as the common passage of acidic water passage 87 and alkaline water passage 80.

Hence, acidic water L3 stored in acidic water storage 37 passes through the common passage downstream of branch pipe 88 and switching valve 89, and is discharged from acidic water outlet 87a toward skin S.

At this time, an acidic water supplying mechanism configured by pump unit 50C supplies acidic water L3 in acidic water storage 37 to skin S of user U. That is, in the present exemplary embodiment, pump unit 50C is further provided with a function as the acidic water supplying mechanism in addition to the alkaline water supplying mechanism and the dirt removing mechanism.

In the present exemplary embodiment, alkaline water L1 in alkaline water storage 33 is not used as a part of wiring as in the third exemplary embodiment. Hence, finger-side electrode 92 is directly connected with circuit board 70 through lead wire 93a, to constitute energization mechanism 90.

Beauty treatment device 10C of the present exemplary embodiment is configured as above.

Hereinafter, a description is given of a beauty treatment method using beauty treatment device 10C having the above configuration, based on an example of operation and effect of beauty treatment device 10C. Note that the basic operation and effect are omitted since they are similar to the basic operation and effect of the third exemplary embodiment, and different operation is mainly described.

First, user U removes lid 32 of tank case 30, and supplies water such as tap water into alkaline water storage 33 and acidic water storage 37 which are divided by diaphragm 103.

Subsequently, voltage is applied to cathode 101 and anode 102 of electrolysis unit 100 which face each other via diaphragm 103, to electrolyze the water. This generates alkaline water L1 in alkaline water storage 33 where cathode 101 is disposed. At the same time, acidic water L3 is generated in acidic water storage 37 where anode 102 is disposed. At this time, alkaline water L1 stored in alkaline water storage 33 is generated by being adjusted to have pH in the range from 9 to 12, for example pH 11.5.

Next, detector 45, provided at tip 42 of nozzle part 40 (flange part 44b), is brought into contact with the surface of skin S of the nostrils, or the like, for example. In this contact state, user U operates switch 22.

Pump unit 50C is driven when switch 22 is operated with beauty treatment device 10C (flange part 44b) in contact with skin S of user U.

Upon driving of pump unit 50C, alkaline water L1 stored in alkaline water storage 33 is sucked into alkaline water passage 80 and then flows. Flowing alkaline water L1 is heated to, for example, about 40° C. (in the range from 37° C. to 50° C.) by heating unit 83. Heated alkaline water L1 is sprayed from alkaline water outlet 80a, formed in nozzle part 40, toward skin S, at the surface of the nostrils, and the like, of user U.

That is, heated alkaline water L1 is sprayed from alkaline water outlet 80a, to be supplied to the surface of skin S of user U. At this time, supplied alkaline water L1 softens the dirt adhered to the pores and the like of user U through hydrolysis or the like. At the same time, the dirt adhered to the pores and the like is blown off and removed by the spraying force of alkaline water L1 sprayed onto skin S. In beauty treatment device 10C of the present exemplary embodiment, during spraying of heated alkaline water L1 onto skin S (e.g., for about three minutes), branch pipe 88 communicating with acidic water storage 37 is closed by switching valve 89.

Next, after removal of the dirt adhered to the pores and the like, the controller of circuit board 70 switches switching valve 89. Acidic water L3 in acidic water storage 37 thereby passes through acidic water passage 87, to be sprayed from acidic water outlet 87a toward skin S, at the surface of the nostrils, and the like, of user U.

Note that acidic water L3 to be sprayed is preferably sprayed in the heated state of, for example, about 40° C. (in the range from 37° C. to 50° C.) by heating unit 83. However, acidic water L3, in particular, may be sprayed in the unheated state.

As described above, a beauty treatment method is performed by using beauty treatment device 10C of the present exemplary embodiment.

The beauty treatment method using beauty treatment device 10C of the fourth exemplary embodiment is as follows. First, heated alkaline water L1 is supplied to skin S of user U by the alkaline water supplying mechanism. While alkaline water L1 is supplied, the dirt attached to skin S of user U is removed by the dirt removing mechanism. Further, after removal of the dirt, acidic water L3 is supplied to skin S of user U by the acidic water supplying mechanism.

By this operation, operation and effect similar to those in the third exemplary embodiment are obtained.

Note that beauty treatment device 10C of the fourth exemplary embodiment includes: acidic water storage 37 that stores acidic water L3 generated in electrolysis unit 100; acidic water passage 87 having acidic water outlet 87a, from which acidic water L3 stored in acidic water storage 37 is discharged; and an acidic water supplying mechanism that supplies acidic water L3 to skin S of user U. It is thereby possible to supply not only alkaline water L1, but also acidic water L3 to skin S.

Further, beauty treatment device 10C of the fourth exemplary embodiment includes, as the acidic water supplying mechanism, pump unit 50C capable of spraying acidic water L3 onto skin S of user U.

Acidic water L3 can be thereby more efficiently supplied to skin S of user U. Further, acidic water L3 can be supplied deep into the pores.

In the beauty treatment method of the fourth exemplary embodiment, by using beauty treatment device 10C, the dirt attached to skin S of user U is removed by the dirt removing mechanism while heated alkaline water L1 is supplied to skin S of user U by the alkaline water supplying mechanism. After removal of the dirt attached to skin S of user U, acidic water L3 is supplied to skin S of user U by the acidic water supplying mechanism.

Acidic water L3 can be thereby supplied to skin S of user U as post-treatment. Further, by the supply of acidic water L3, pH of skin S can be recovered to a normal region. As a result, the state of skin S of user U can be managed.

In the present exemplary embodiment, the description has been given by taking nozzle part 40 as an example. However, the present disclosure is not limited thereto. For example, nozzle part 40A of the second exemplary embodiment may be used.

In the present exemplary embodiment, the description has been given by taking, as an example, the beauty treatment method in which the dirt attached to skin S of user U is removed while heated alkaline water L1 is supplied to skin S, and acidic water L3 is supplied to skin S after removal of the dirt. However, the present disclosure is not limited thereto. For example, by using beauty treatment device 10C, the dirt attached to skin S of user U is removed again using alkaline water by the dirt removing mechanism after heated alkaline water L1 is supplied to skin S of user U. The beauty treatment method may be a treatment in which acidic water L3 is supplied to skin S of user U by the acidic water supplying mechanism after removal of the dirt attached to skin S. The state of skin S of user U can be thereby managed.

### Fifth Exemplary Embodiment

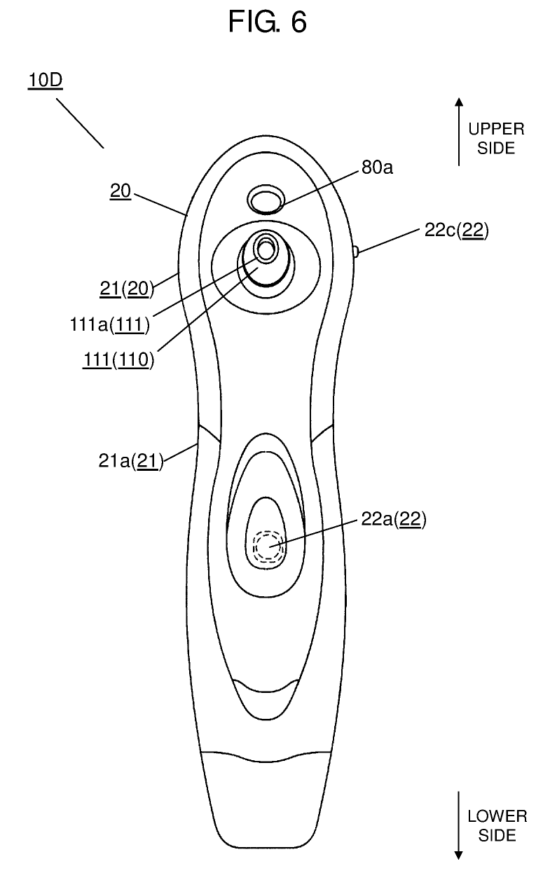

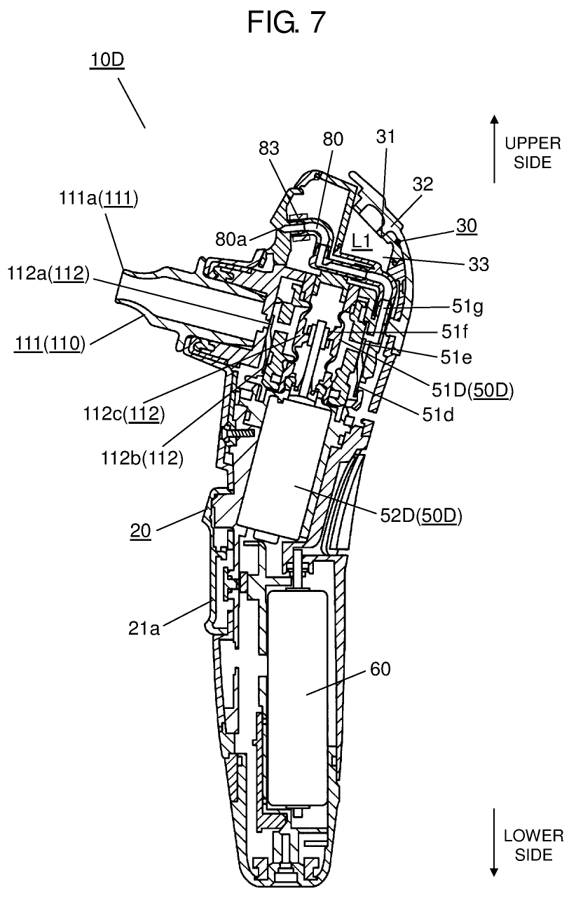

Hereinafter, a beauty treatment device according to the fifth exemplary embodiment will be described with reference to FIGS. 6 and 7.

FIG. 6 is a front view showing the beauty treatment device according to the fifth exemplary embodiment of the present disclosure. FIG. 7 is a sectional view showing the beauty treatment device according to the fifth exemplary embodiment.

As shown in FIGS. 6 and 7, beauty treatment device 10D of the present exemplary embodiment is different from beauty treatment device 10 of the first exemplary embodiment in that casing 21 is directly provided with alkaline water outlet 80a, spray switch 22c, suction mechanism 110, and the like, and is not provided with a nozzle part, a finger-side electrode, a skin-side electrode, or the like. Except for the above, beauty treatment device 10D basically has a configuration similar to the configuration of beauty treatment device 10 of the first exemplary embodiment.

That is, beauty treatment device 10D of the present exemplary embodiment includes body 20 provided with gripper 21a, tank case 30, and the like. Tank case 30 is detachably mounted to an upper rear part of body 20, for example.

Body 20 includes elongated, substantially tubular (including tubular) casing 21 formed of an insulating synthetic resin, such as an ABS resin. Casing 21 accommodates main components, described below, in the tube.

Casing 21 includes gripper 21a at a substantially central part (including a central part) in the longitudinal direction. Gripper 21a includes switch 22, such as power supply switch 22a for switching ON/OFF of a power supply on the front surface of beauty treatment device 10D, and spray switch 22c on the upper side surface of beauty treatment device 10D.

It is configured such that, upon mounting of tank case 30 to the upper rear part of body 20, alkaline water storage 33 for storing alkaline water L1 is formed inside tank case 30.

Opening 31 to be closed by lid 32 is formed in tank case 30. By removal of lid 32, water can be supplied from opening 31 into alkaline water storage 33.

Similarly to each of the above exemplary embodiments, in beauty treatment device 10D of the present exemplary embodiment, lid 32 is removed, a tablet for pH adjustment, for example, is put into alkaline water storage 33, and water such as tap water is supplied. This generates alkaline water L1. At this time, alkaline water L1 stored in alkaline water storage 33 is adjusted so as to have pH in the range from 9 to 12.

Further, also in the present exemplary embodiment, it can be configured such that previously prepared alkaline water L1 is directly stored in alkaline water storage 33. Further, it can also be configured such that an electrolysis unit is provided to generate alkaline water L1, as described in the third and fourth exemplary embodiments.

Moreover, similarly to each of the above exemplary embodiments, beauty treatment device 10D of the present exemplary embodiment includes alkaline water passage 80, the alkaline water supplying mechanism, heating unit 83, the dirt removing mechanism, and the like. Alkaline water passage 80 has alkaline water outlet 80a provided in casing 21. Alkaline water outlet 80a discharges (sprays) alkaline water L1 stored in alkaline water storage 33 to skin S. Then, the alkaline water supplying mechanism supplies alkaline water L1 to skin S of user U. Heating unit 83 heats alkaline water L1. The dirt attached to skin S of user U is removed by the dirt removing mechanism.

In the present exemplary embodiment, pump unit 50D is functioned as the alkaline water supplying mechanism. That is, it is configured such that by activation of pump unit 50D built-in in the hollow (the tube) of casing 21, alkaline water L1 in alkaline water storage 33 passes through alkaline water passage 80 and is discharged (sprayed) from alkaline water outlet 80a.

At this time, heating unit 83 heats alkaline water L1 to, for example, about 40° C. (in the range from 37° C. to 50° C.). It is thus configured such that heated alkaline water L1 is discharged (sprayed) from alkaline water outlet 80a.

Pump unit 50D includes, for example, diaphragm pump 51D and electric motor 52D for driving pump 51D. Pump unit 50D and the alkaline water supplying mechanism constitute suction mechanism 110 described above.

Electric motor 52D is electrically connected to storage battery 60 constituting a power supply, and is driven by electric power of storage battery 60.

Pump 51D is provided with suction valve 51d, discharge valve 51e, elastic body 51f, discharge port 51g, and the like, and is disposed communicating with the outside. Suction valve 51d sucks external air. Discharge valve 51e is integrally provided with suction valve 51d, and performs closing-opening operation opposite to opening-closing operation of suction valve 51d. Elastic body 51f is made up, for example, of a diaphragm, and moves to change a volume of an internal space of pump 51D. Discharge port 51g is communicated with alkaline water passage 80. Discharge port 51g feeds air sucked from suction valve 51d to alkaline water passage 80.

At this time, upon driving of pump 51D, by user U's operation of spray switch 22c, the air is fed from discharge port 51g to alkaline water passage 80. The fed air presses alkaline water L1 in alkaline water passage 80. Alkaline water L1 is discharged (sprayed) from alkaline water outlet 80a to the outside of beauty treatment device 10D. As a result, sprayed alkaline water L1 is supplied to skin S of user U, for example.

Spray switch 22c is provided on the upper side surface of body 20, and switches ON/OFF of the spraying of alkaline water L1. That is, it is configured such that alkaline water L1 is discharged (sprayed) from alkaline water outlet 80a by operation of spray switch 22c.

Further, beauty treatment device 10D of the present exemplary embodiment includes suction mechanism 110 that sucks the dirt attached to skin S of user U. Suction mechanism 110 functions as the dirt removing mechanism described above.

Suction mechanism 110 is provided on the upper front surface of body 20, and includes suction nozzle 111, suction pump 112, and the like. Suction nozzle 111 is detachably mounted below the region provided with alkaline water outlet 80a of casing 21.

Suction pump 112 is configured by a diaphragm pump, similarly to pump 51D. Specifically, suction pump 112 is configured by suction valve 112a, discharge valve 112b, elastic body 112c, and the like. Suction valve 112a opens and closes the rear end (the back side) of suction nozzle 111. Discharge valve 112b is integrally provided with suction valve 112a, and performs closing-opening operation which is opposite to opening-closing operation of suction valve 112a. Elastic body 112c is made up, for example, of a diaphragm, and operates to change a volume of an internal space of suction pump 112.

Suction pump 112 simultaneously or independently operates by driving of electric motor 52D, similarly to diaphragm pump 51D. Specifically, suction pump 112 is operated with skin S of user U in contact with suction opening 111a at the tip of suction nozzle 111. This leads to the following operation to cause suction mechanism 110 to generate suction force.

First, when elastic body 112c deforms in such a direction as to increase the volume of the internal space of suction pump 112, suction valve 112a opens, and discharge valve 112b closes simultaneously. An internal space of suction nozzle 111 is thereby communicated with the internal space of suction pump 112 to increase the volume. Hence, the pressure inside the space decreases.

Next, when elastic body 112c deforms in such a direction as to decrease the volume of the internal space of suction pump 112, suction valve 112a closes, and the internal space of suction nozzle 111 is closed simultaneously. Hence, the pressure inside the space is maintained, and the pressure does not increase or decrease.

On the other hand, when suction valve 112b is opened, the air inside suction pump 112 is discharged from the discharge port. The pressure inside the space of suction pump 112 thereby becomes the same as the pressure of the external air.

Continuous repetition of the above deformation of elastic body 112c leads to a gradual decrease in pressure of the internal space of suction nozzle 111. Specifically, a deformation quantity of elastic body 112c is adjusted such that gradients of the decrease and the increase in pressure are different. For this reason, when the deformation of elastic body 112c is continuously repeated, the pressure decreases by integration. This results in generation of suction force in suction mechanism 110.

That is, as described above, in beauty treatment device 10D of the present exemplary embodiment, the driving of electric motor 52D also leads to activation of suction pump 112. It is thus configured such that diaphragm pump 51D and suction pump 112 are simultaneously operated by driving one electric motor 52D. Hence, suction of dirt attached to skin S by suction nozzle 111 and discharge (spraying) of alkaline water L1 from alkaline water outlet 80a can be simultaneously performed.

Note that pump 51D and suction pump 112 are not necessarily simultaneously activated. For example, pump 51D and suction pump 112 may be independently activated. Thereby, the keratotic plugs and the like can be further softened, and then removed. As a result, the dirt attached to skin S of user U can be more effectively removed.

Beauty treatment device 10D of the present exemplary embodiment is configured as above.

Hereinafter, a description is given of a beauty treatment method using beauty treatment device 10D having the above configuration, based on an example of operation and effect of beauty treatment device 10D. Note that basic operation and effect are omitted since they are similar to, for example, the basic operation and effect of the first exemplary embodiment, and different operation is mainly described.

First, user U removes lid 32 of tank case 30, puts a tablet for pH adjustment into alkaline water storage 33, and supplies water such as tap water. This generates alkaline water L1 adjusted to have a pH similar to that in the first exemplary embodiment. In the present exemplary embodiment, alkaline water L1 with pH in the preferable range from 9 to 12, for example about pH 11.5, is generated and stored into alkaline water storage 33.

Next, the tip (suction opening 111a) of suction nozzle 111 is brought into contact with the surface of skin S of the nostrils, for example. In this contact state, user U operates switch 22. Electric motor 52D is thereby driven.

Upon driving of electric motor 52D, diaphragm pump 51D is activated. Air sucked from suction valve 51d is thereby fed to alkaline water passage 80. The fed air discharges (sprays) alkaline water L1 in alkaline water passage 80 from alkaline water outlet 80a toward skin S of user U.

At this time, heating unit 83 heats alkaline water L1 to be sprayed to, for example, about 40° C. (in the range from 37° C. to 50° C.). Heated alkaline water L1 is thus discharged (sprayed) to skin S of user U. Dirt attached to skin S is thereby softened through hydrolysis or the like.

Further, when electric motor 52D is driven, suction pump 112 is activated simultaneously with activation of pump 51D. Suction pump 112 thereby sucks and removes the dirt in skin S which has been softened by alkaline water L1. This enables skin S to be held in a dirt-free state.

As described above, a beauty treatment method is performed by using beauty treatment device 10D of the present exemplary embodiment.

The beauty treatment method using beauty treatment device 10D of the present exemplary embodiment is as follows. First, heated alkaline water L1 is sprayed and supplied to skin S of user U by the alkaline water supplying mechanism. While alkaline water L1 is supplied, the dirt attached to skin S of user U is removed by the dirt removing mechanism. Hence, operation and effect similar to those in the first exemplary embodiment are obtained.

Further, beauty treatment device 10D of the present exemplary embodiment includes, as the dirt removing mechanism, suction mechanism 110 that sucks the dirt attached to skin S of user U.

Suction mechanism 110 thus sucks the keratotic plugs and the dirt in the pores which have been softened by spraying of alkaline water L1. As a result, the dirt attached to skin S of user U can be more reliably removed.

Note that the alkaline water holder described in the second exemplary embodiment may be provided on an outer periphery of suction nozzle 111. In this case, alkaline water L1 is supplied by the alkaline water supplying mechanism from a spray unit to the alkaline water holder through the air or the passage such as the tube. Accordingly, softening of the dirt such as the keratotic plugs by alkaline water L1 and removal of the dirt by sucking by suction mechanism 110 can be simultaneously realized.

### Sixth Exemplary Embodiment

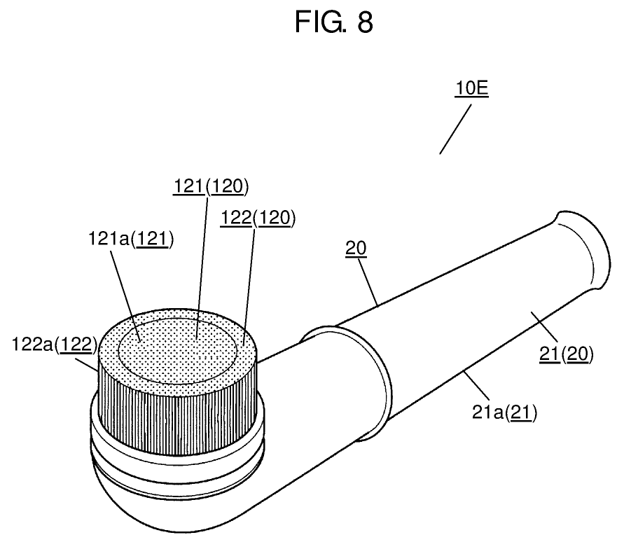

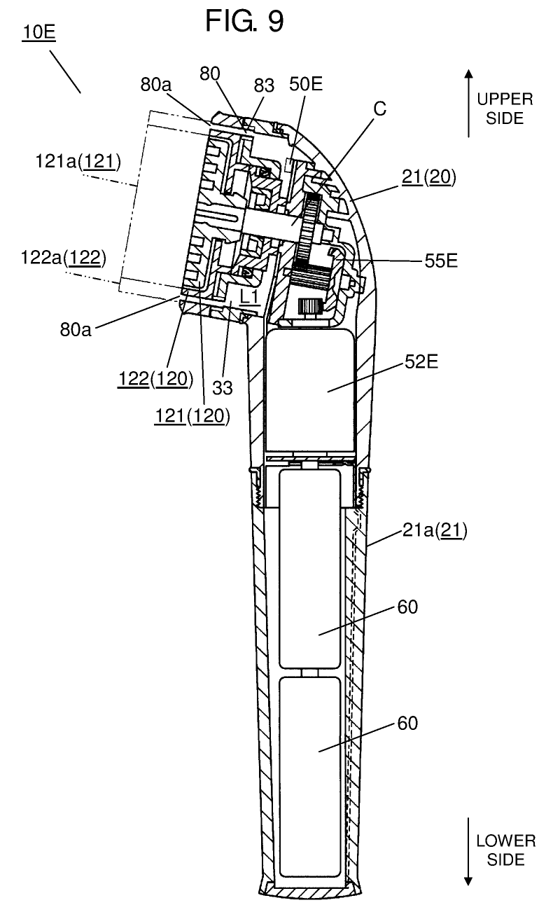

Hereinafter, a beauty treatment device according to the sixth exemplary embodiment will be described with reference to FIGS. 8 and 9.

FIG. 8 is a perspective view showing a beauty treatment device according to the sixth exemplary embodiment of the present disclosure. FIG. 9 is a sectional view showing the beauty treatment device according to the sixth exemplary embodiment.

As shown in FIGS. 8 and 9, beauty treatment device 10E of the present exemplary embodiment is different from beauty treatment device 10 of the first exemplary embodiment in that beauty treatment device 10E includes brush unit 120 provided at the tip of alkaline water passage 80, rotary transmission mechanism 55E, and the like, and is not provided with a finger-side electrode, a skin-side electrode, a tank case, or the like. Except for the above, beauty treatment device 10E basically has a configuration similar to the configuration of beauty treatment device 10 of the first exemplary embodiment.

That is, beauty treatment device 10E of the present exemplary embodiment includes body 20 provided with gripper 21a.

Body 20 includes elongated, substantially tubular (including tubular) casing 21 formed of an insulating synthetic resin, such as an ABS resin. Casing 21 accommodates main components, described below, in the tube.

Casing 21 has a power supply switch (not shown) for switching ON/OFF of a power supply.

Further, casing 21 includes, in the tube, alkaline water storage 33 for storing alkaline water L1.

Similarly to each of the above exemplary embodiments, in beauty treatment device 10E of the present exemplary embodiment, for example, a tablet for pH adjustment is put into alkaline water storage 33, and water such as tap water is supplied. This generates alkaline water L1. At this time, alkaline water L1 stored in alkaline water storage 33 is adjusted so as to have pH in the range from 9 to 12.

Also in the present exemplary embodiment, previously prepared alkaline water L1 can be directly stored in alkaline water storage 33. Further, an electrolysis unit can be provided to generate alkaline water L1, as described in the third and fourth exemplary embodiments.

Moreover, similarly to each of the above exemplary embodiments, beauty treatment device 10E of the present exemplary embodiment includes alkaline water passage 80, the alkaline water supplying mechanism, heating unit 83, the dirt removing mechanism, and the like. Alkaline water passage 80 has alkaline water outlet 80a provided in casing 21. Alkaline water outlet 80a discharges alkaline water L1 stored in alkaline water storage 33 to skin S. Then, the alkaline water supplying mechanism supplies alkaline water L1 to skin S of user U. Heating unit 83 heats alkaline water L1. The dirt attached to skin S of user U is removed by the dirt removing mechanism.

In the present exemplary embodiment, pump unit 50E functions as the alkaline water supplying mechanism. That is, it is configured such that, by activation of pump unit 50E built-in in the hollow (the tube) of casing 21, alkaline water L1 in alkaline water storage 33 passes through alkaline water passage 80 and is discharged from alkaline water outlet 80a. At this time, it is possible to use, as pump unit 50E, various types of pumps described in the above exemplary embodiments, such as the piston pump and the diaphragm pump.

Heating unit 83 heats alkaline water L1 to, for example, about 40° C. (in the range from 37° C. to 50° C.). Heated alkaline water L1 is thereby discharged from alkaline water outlet 80a.

Further, beauty treatment device 10E of the present exemplary embodiment includes brush unit 120 having fibrous brushes 121a, 122a. Brush unit 120 functions as the dirt removing mechanism.

Specifically, brush unit 120 is configured by rotary brush part 121 and fixed brush part 122. Rotary brush part 121 includes fibrous brush 121a described above, and is rotatably supported to casing 21. Fixed brush part 122 includes fibrous brush 122a, and fibrous brush 122a is fixed and disposed over the whole outer periphery of fibrous brush 121a.

Rotary brush part 121 is coupled with electric motor 52E via rotary transmission mechanism 55E including a gear and the like. By driving of electric motor 52E, rotary brush part 121 is rotated around axis C.

Electric motor 52E is electrically connected to storage battery 60 constituting a power supply, and is driven by electric power of storage battery 60.

Further, in beauty treatment device 10E of the present exemplary embodiment, alkaline water storage 33 for storing alkaline water L1 is formed in a space between casing 21 and rotary brush part 121. Note that alkaline water storage 33 is not limited to be formed in the above space, but alkaline water storage 33 may simply be formed anywhere in the tube of casing 21.

Beauty treatment device 10E of the present exemplary embodiment is configured as above.

Hereinafter, a description is given of a beauty treatment method using beauty treatment device 10E having the above configuration, based on an example of operation and effect of beauty treatment device 10E. Note that basic operation and effect are omitted since they are similar to, for example, the basic operation and effect of the first exemplary embodiment, and different operation is mainly described.

First, user U puts a tablet for pH adjustment into alkaline water storage 33, and supplies water such as tap water. This generates alkaline water L1 adjusted to have a similar pH to in the first exemplary embodiment. At this time, alkaline water L1 with pH in the preferable range from 9 to 12, for example about pH 11.5, is generated and stored into alkaline water storage 33.

Subsequently, the tips of fibrous brush 121a of rotary brush part 121 and fibrous brush 122a of fixed brush part 122 are, for example, brought into contact with the surface of skin S of the nostrils, and the like. In this contact state, user U operates a switch, not shown. This drives electric motor 52E and pump unit 50E.

Upon driving of pump unit 50E, alkaline water L1 in alkaline water passage 80 is discharged (supplied) from alkaline water outlet 80a toward skin S of user U.

At this time, heating unit 83 heats alkaline water L1 to be discharged to, for example, about 40° C. (in the range from 37° C. to 50° C.). Heated alkaline water L1 is thus discharged (supplied) to skin S of user U. Dirt attached to skin S is thereby softened through hydrolysis or the like.

Further, upon driving of electric motor 52E, rotary brush part 121 is rotated via rotary transmission mechanism 55E. Thereby, brush unit 120, that is, rotary brush part 121 and fixed brush part 122 scrape and remove the dirt in skin S which has been softened by heated alkaline water L1.

In the present exemplary embodiment, alkaline water L1 discharged from alkaline water outlet 80a is supplied to skin S of user U while being held with fibrous brushes 121a, 122a. For this reason, fibrous brushes 121a, 122a have a function of the alkaline water holder as well as a function of the dirt removing mechanism for scraping the dirt in skin S.

As described above, a beauty treatment method is performed by using beauty treatment device 10E of the present exemplary embodiment.

The beauty treatment method using beauty treatment device 10E of the present exemplary embodiment is as follows. First, heated alkaline water L1 is supplied to skin S of user U by the alkaline water supplying mechanism. While alkaline water L1 is supplied, the dirt attached to skin S of user U is removed by the dirt removing mechanism. Hence, operation and effect similar to those in the first exemplary embodiment are obtained.

Further, beauty treatment device 10E of the present exemplary embodiment includes brush unit 120 having fibrous brushes 121a, 122a as the dirt removing mechanism.

The softened keratotic plugs and the like are scraped and removed by brushes 121a, 122a constituting brush unit 120. This results in easier removal of the dirt attached to skin S of user U.

Moreover, the dirt removing mechanism of beauty treatment device 10E of the present exemplary embodiment includes motor 52E that rotates and drives brush 122a.

Hence, the dirt attached to skin S of user U can be more easily and reliably removed.

While the preferred exemplary embodiments of the present disclosure have been described above, the present disclosure is not limited to the above exemplary embodiment, and various modifications are possible.

For example, the configuration of the beauty treatment device is not limited to the configuration described in each of the above exemplary embodiments. The configuration described in each of the above exemplary embodiments may be combined as appropriate to form a beauty treatment device.

Further, a plurality of kinds of nozzle parts, including nozzle part 40 of the first exemplary embodiment and nozzle part 40A of the second exemplary embodiment, and a body portion other than the nozzle part (the body and the tank case) may constitute a beauty set. That is, the kind of nozzle part may be changeable in accordance with application of the beauty treatment device. Further, the beauty treatment device may include a plurality of kinds of the body portions other than the nozzle part (the body and the tank case). Accordingly, a beauty treatment device excellent in universal use can be provided.

In the first to fourth exemplary embodiments, the piston pump has been illustrated as the pump unit, and in the fifth exemplary embodiment, the diaphragm pump has been illustrated as the pump unit. However, the present disclosure is not limited thereto. For example, various types of pumps, such as a tube pump, may be used.

Needless to say, specifications (a shape, a size, a layout, etc.) of each of the body, the tank case, and other details are changeable as appropriate.

As described above, the beauty treatment device of the present disclosure includes an alkaline water storage that stores alkaline water to be supplied to the skin of the user, and an alkaline water passage having an alkaline water outlet, from which alkaline water stored in the alkaline water storage is discharged. Further, the beauty treatment device may be configured to include: an alkaline water supplying mechanism that supplies the alkaline water to the skin of the user; a heating unit that heats the alkaline water; and a dirt removing mechanism that removes dirt attached to the skin of the user.

With this configuration, hydrolysis of proteins of the keratotic plugs and the like adhered to the pores and the like is promoted by the heated alkaline water to soften the adhered dirt. Accordingly, the dirt adhered to the pores and the like can be more easily removed.

The dirt removing mechanism of the beauty treatment device of the present disclosure may include a pump unit capable of spraying the alkaline water onto the skin of the user.

With this configuration, the dirt removing mechanism sprays the alkaline water to the skin of the user to remove the dirt adhered to the pores and the like. It is thereby possible to remove the dirt by the spraying force, while softening the dirt. As a result, the dirt adhered to the pores and the like can be more efficiently removed. Further, the alkaline water can be sprayed deep into the pores. It is thus possible to physically act the alkaline water on the dirt located deep inside the pores, so as to effectively remove the dirt.

Further, in the beauty treatment device of the present disclosure, a splash preventer for preventing splashing of the alkaline water may be provided near the alkaline water outlet.

It is thereby possible to prevent scattering of the alkaline water discharged from the alkaline water outlet to the eyes or the like

In the beauty treatment device of the present disclosure, a guide part may be provided on the periphery of the alkaline water outlet, the guide part guiding the alkaline water so as to be discharged in one direction.

Thereby, the alkaline water can be discharged in the substantially vertical direction (including the vertical direction) to the skin, and supplied deep into the pores. As a result, the dirt such as the keratotic plugs can be more reliably removed.

Further, in beauty treatment device of the present disclosure, a detector for detecting a state of contact with the skin of the user may be provided on the periphery of the alkaline water outlet.

It is thereby possible to prevent discharge of the alkaline water while the periphery of the alkaline water outlet is not in contact with the skin. As a result, usability of the beauty treatment device is improved.

The alkaline water supplying mechanism of the beauty treatment device of the present disclosure may include a pump unit capable of spraying the alkaline water onto the skin of the user.

The alkaline water can be thereby sprayed onto the skin of the user, to be more efficiently supplied to the skin of the user. Further, the alkaline water can be supplied deep into the pores. Hence, the dirt located deep inside the pores can be more effectively removed.

Further, the heating unit of the beauty treatment device of the present disclosure may heat the alkaline water to be discharged from the alkaline water outlet such that a temperature of the alkaline water is in a range from 37° C. to 50° C.

With this configuration, it is possible to discharge, to the skin, the alkaline water having a temperature equal to or higher than the temperature of the skin. The dirt such as the keratotic plugs can be thereby more easily removed. The temperature of the alkaline water to be discharged to the skin is set equal to or lower than 50° C. This enables suppression of a thermal effect exerted on the skin. As a result, a possibility of damaging the skin can be prevented in advance.

Further, in the beauty treatment device of the present disclosure, pH of the alkaline water may be set in a range from 9 to 12.

This can suppress irritation by the alkaline water on the eyes, skin and the like of the user. Hence, the dirt such as the keratotic plugs can be more easily removed while the irritation on the skin and the like by the alkaline water is suppressed.

The alkaline water supplying mechanism of the beauty treatment device of the present disclosure may include an alkaline water holder formed at the peripheral edge of the alkaline water outlet.

With this configuration, the alkaline water can be supplied from the alkaline water holder to the skin during use of the beauty treatment device. The dirt such as the keratotic plugs can be thereby more reliably softened.

Further, the dirt removing mechanism of the beauty treatment device of the present disclosure may include a suction mechanism that sucks the dirt attached to the skin of the user.

With this configuration, the softened keratotic plugs and the dirt in the pores are sucked out by the suction mechanism. The dirt attached to the skin of the user can be thereby more reliably removed.

The dirt removing mechanism of the beauty treatment device of the present disclosure may include a brush unit having a fibrous brush.

With this configuration, the softened keratotic plugs and the like are scraped and removed by the brush. The dirt attached to the skin of the user can be thereby more easily removed.

The dirt removing mechanism of the beauty treatment device of the present disclosure may include a motor that rotates and drives the brush.

Hence, the dirt attached to the skin of the user can be more easily and reliably removed.

The beauty treatment device of the present disclosure may include an alkaline water generator that generates alkaline water.

Hence, the alkaline water can be easily generated by using tap water or the like.

The alkaline water generator of the beauty treatment device of the present disclosure may be configured to include an electrolysis unit having a cathode, an anode, and a diaphragm disposed between the cathode and the anode.

This enables generation of the alkaline water with a simpler configuration.

The beauty treatment device of the present disclosure may be configured to include: an acidic water storage that stores acidic water generated in the electrolysis unit; an acidic water passage having an acidic water outlet, from which acidic water stored in the acidic water storage is discharged; and an acidic water supplying mechanism that supplies the acidic water to the skin of the user.

It is thereby possible to supply not only the alkaline water but also the acidic water to the skin.

The acidic water supplying mechanism of the beauty treatment device of the present disclosure may include a pump unit capable of spraying the acidic water to the skin of the user.

The acidic water can be thereby more efficiently supplied to the skin of the user. Further, the acidic water can be supplied deep into the pores. As a result, pH of the skin can be recovered to a normal region.

The beauty treatment device of the present disclosure may be configured to include: a liquid storage that stores a liquid different from the alkaline water; a liquid passage having a liquid outlet, from which a liquid stored in the liquid storage is discharged; and a liquid supplying mechanism that supplies the liquid to the skin of the user.

It is thereby possible to supply, to the skin, not only the alkaline water but also the liquid different from the alkaline water. As a result, the alkaline water remaining on the skin can be effectively removed.

The dirt removing mechanism of the beauty treatment device of the present disclosure may include a pump unit capable of spraying the liquid to the skin of the user.

Hence, the liquid can be more easily supplied deep into the pores to easily remove dirt.

In the beauty treatment method of the present disclosure, by using the above beauty treatment device, the dirt attached to the skin of the user may be removed by the dirt removing mechanism while the heated alkaline water is supplied to the skin of the user by the alkaline water supplying mechanism.

According to this method, the dirt attached to the skin of the user can be more easily removed. Further, it is possible to more easily remove the dirt attached to the skin of the user without setting the time for pre-treatment. Hence, the dirt attached to the skin can be removed in a shorter time.

In the beauty treatment method of the present disclosure, by using the above beauty treatment device, the dirt attached to the skin of the user may be removed by the dirt removing mechanism after the heated alkaline water is supplied to the skin of the user by the alkaline water supplying mechanism.

According to this method, the dirt attached to the skin of the user can be more easily removed. Proteins of the keratotic plugs and the like may be softened by the alkaline water through hydrolysis, and then removed. Hence, the dirt attached to the skin can be more reliably removed.

In the beauty treatment method of the present disclosure, by using the above beauty treatment device, the dirt attached to the skin of the user may be removed by the dirt removing mechanism while the heated alkaline water is supplied to the skin of the user by the alkaline water supplying mechanism, and the acidic water may be supplied to the skin of the user by the acidic water supplying mechanism after the removal of the dirt attached to the skin of the user.

In the beauty treatment method of the present disclosure, by using the above beauty treatment device, dirt attached to the skin of the user may be removed by the dirt removing mechanism after the heated alkaline water is supplied to the skin of the user by the alkaline water supplying mechanism, and the acidic water may be supplied to the skin of the user by the acidic water supplying mechanism after the removal of the dirt attached to the skin of the user.

According to these methods, the acidic water can be supplied to the skin of the user as post-treatment. Thus, the acidic water is supplied to the skin to recover pH of the skin to a normal region. As a result, the state of the skin of the user can be efficiently managed.

What is claimed is:

1. A beauty treatment device comprising:
an alkaline water storage that stores alkaline water to be supplied to a skin of a user;
an alkaline water passage having an alkaline water outlet, from which the alkaline water stored in the alkaline water storage is discharged;
an alkaline water supplying mechanism that supplies the alkaline water to the skin of the user;
a heating unit that heats the alkaline water; and
a dirt removing mechanism that removes dirt attached to the skin of the user.

2. The beauty treatment device according to claim 1, wherein the dirt removing mechanism includes a pump unit capable of spraying the alkaline water onto the skin of the user.

3. The beauty treatment device according to claim 1, wherein a splash preventer that prevents splashing of the alkaline water is provided near the alkaline water outlet.

4. The beauty treatment device according to claim 1, wherein a guide part is provided on a periphery of the alkaline water outlet, the guide part configured to guide the alkaline water so as to be discharged in one direction.

5. The beauty treatment device according to claim 1, wherein a detector is provided on a periphery of the alkaline water outlet, the detector configured to detect a state of contact with the skin of the user.

6. The beauty treatment device according to claim 1, wherein the alkaline water supplying mechanism includes a pump unit capable of spraying the alkaline water onto the skin of the user.

7. The beauty treatment device according to claim 1, wherein the heating unit heats the alkaline water discharged from the alkaline water outlet such that a temperature of the alkaline water becomes 37° C. to 50° C.

8. The beauty treatment device according to claim 1, wherein the alkaline water has pH in a range from 9 to 12.

9. The beauty treatment device according to claim 1, wherein the alkaline water supplying mechanism includes an alkaline water holder formed at a peripheral edge of the alkaline water outlet.

10. The beauty treatment device according to claim 1, wherein the dirt removing mechanism includes a suction mechanism that sucks the dirt attached to the skin of the user.

11. The beauty treatment device according to claim 1, wherein the dirt removing mechanism includes a brush unit having a fibrous brush.

12. The beauty treatment device according to claim 11, wherein the dirt removing mechanism includes a motor that rotates and drives the brush.

13. The beauty treatment device according to claim 1, further comprising an alkaline water generator that generates the alkaline water.

14. The beauty treatment device according to claim 13, wherein the alkaline water generator includes an electrolysis unit having a cathode, an anode, and a diaphragm disposed between the cathode and the anode.

15. The beauty treatment device according to claim 14, further comprising:
an acidic water storage that stores acidic water generated in the electrolysis unit;
an acidic water passage having an acidic water outlet, from which the acidic water stored in the acidic water storage is discharged; and
an acidic water supplying mechanism that supplies the acidic water to the skin of the user.

16. The beauty treatment device according to claim 15, wherein the acidic water supplying mechanism includes a pump unit capable of spraying the acidic water onto the skin of the user.

17. The beauty treatment device according to claim 1, further comprising:
a liquid storage that stores a liquid different from the alkaline water;
a liquid passage having a liquid outlet, from which the liquid stored in the liquid storage is discharged; and
a liquid supplying mechanism that supplies the liquid to the skin of the user.

18. The beauty treatment device according to claim 17, wherein the dirt removing mechanism includes a pump unit capable of spraying the liquid onto the skin of the user.

19. A beauty treatment method comprising, by use of the beauty treatment device according to claim 1, removing the dirt attached to the skin of the user by the dirt removing mechanism while the heated alkaline water is supplied to the skin of the user by the alkaline water supplying mechanism.

20. A beauty treatment method comprising, by use of the beauty treatment device according to claim 1, removing the dirt attached to the skin of the user by the dirt removing mechanism after the heated alkaline water is supplied to the skin of the user by the alkaline water supplying mechanism.

21. A beauty treatment method comprising:
by use of the beauty treatment device according to claim 15,
removing the dirt attached to the skin of the user by the dirt removing mechanism while the heated alkaline water is supplied to the skin of the user by the alkaline water supplying mechanism; and
supplying the acidic water to the skin of the user by the acidic water supplying mechanism after the removal of the dirt attached to the skin of the user.

22. A beauty treatment method comprising:
by use of the beauty treatment device according to claim 15,
removing the dirt attached to the skin of the user by the dirt removing mechanism after the heated alkaline water is supplied to the skin of the user by the alkaline water supplying mechanism; and
supplying the acidic water to the skin of the user by the acidic water supplying mechanism after the removal of the dirt attached to the skin of the user.
